(19) United States
(12) Patent Application Publication
(10) Pub. No.: US 2026/0340748 A1
(43) Pub. Date: Oct. 29, 2026

(54) SYSTEM AND METHOD FOR CREATING A VIDEO WILL

(71) Applicant: Jean-Marc Zimmerman, Westfield, NJ (US)

(72) Inventor: Jean-Marc Zimmerman, Westfield, NJ (US)

(21) Appl. No.: 19/270,465

(22) Filed: Jul. 15, 2025

Related U.S. Application Data
(60) Provisional application No. 63/671,367, filed on Jul. 15, 2024.

(51) Int. Cl. G06Q 50/18; G06Q 10/10; H04L 9/00

(52) U.S. Cl. CPC G06Q 50/186; G06Q 10/10; H04L 9/50; G06Q 2220/00

(57) ABSTRACT

A system and method for providing a video will whereby a video recording of a testator answering questions or prompts, wherein: the recorded video will can be edited, securely stored on a server in the cloud; the competency of the testator to execute a will can be determined; and AI can be used to create the will from answers provided by the testator, ensure that the created will complies with the requisite state law and choice of law; and video connections can be used to authenticate the identity of the testator, and have the will witnessed and notarized.

### FIELD OF THE INVENTION

The present invention pertains to a system and method for creating a video or electronic will.

### INCORPORATION BY REFERENCE

Citation or identification of any reference herein, in any section of this application, shall not be construed as an admission that such reference is necessarily available as prior art to the present application. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The incorporation by reference does not extend to teachings which are inconsistent with all embodiments of the invention as expressly described herein (which may be treated as counter examples), and is evidence of a proper interpretation by persons of ordinary skill in the art of the terms, phrases and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the express specification, references cited for propositions, incorporated references, academic literature in the field, commercial literature in the field, field-specific dictionaries, lay literature in the field, general purpose dictionaries, and common understanding. Where the issue of interpretation of claim amendments arises, the hierarchy is modified to include arguments made during the prosecution and accepted without retained recourse.

### BACKGROUND OF THE INVENTION

Conventional legal documents such as wills are typically created and then printed in a hardcopy paper format to be signed, witnessed and notarized in accordance with jurisdictional law.

Conventional paper wills have numerous drawbacks including that they do not enable the competency of the testator at the time the will was executed to be ascertained, they do not enable the authenticity of the will to be confirmed (other than by forensic evidence and testimony of the witnesses, who may be unavailable), and they do not ensure that the version of the will being relied upon to make bequests to beneficiaries is authentic and/or the latest version of the testator's will. In addition, beneficiaries, e.g., a spouse or offspring of a testator, are often unable to find the testator's executed will after the testator dies because the will was not stored in a manner accessible to the beneficiaries.

A video recording of a will, independently or when used to supplement a traditional, properly executed written will, can be a valuable tool for interpreting the testator's competence and intent, and various information technology and cryptography may be used to determine authenticity, and verify that the will is indeed the last will and testament.

No state in the U.S. enforces a video will on its own. Most states have strict formalities for the creation of a valid will, which typically must be in writing, signed by the testator, and attested to by two witnesses. A number of states now recognize electronic wills (“e-wills”).

States that have adopted a version of the Uniform Electronic Wills Act (UEWA), such as Colorado, North Dakota, Utah, and Washington, permit electronic wills that are readable as text when signed. The UEWA does not currently accommodate purely audio or video wills unless they are transcribed into text and then signed. Other states like Arizona, Florida, Illinois, and Indiana have also enacted legislation for electronic wills with specific requirements. In some cases, these statutes allow for remote witnessing via audio-visual technology. Even in jurisdictions where video wills are not independently valid, a video recording can serve as crucial extrinsic evidence in probate proceedings. Courts may admit such evidence to clarify ambiguities in a written will or to assess the testator's state of mind.

A video can provide a powerful, direct view of the testator's mental state. Visual and auditory evidence of the testator's demeanor, duress, clarity of speech, and cognitive function at the time of the will's execution can be persuasive in demonstrating they were of sound mind and not under duress or undue influence. It can also be useful for assessing changes in demeanor and competence over time. For instance, a video showing the testator articulating their wishes can counter claims of incapacity.

A video recording can serve as powerful evidence that the testator was of sound mind and not under duress or undue influence at the time the will was made. The video can visually and audibly demonstrate the testator's lucidity and rational state of mind.

In cases where a written will is ambiguous, a video can be used to clarify the testator's intentions. For example, a testator could use a video to explain their reasons for distributing their assets in a particular way, which could help to prevent family disputes.

A video recording of the will-signing ceremony can demonstrate that all legal formalities were properly followed, including the presence and attestation of witnesses.

Courts generally aim to uphold the testator's original intent. When a will contains ambiguous language, extrinsic evidence is often admissible to resolve the uncertainty. A video in which the testator explains their reasoning for certain bequests can offer clear evidence of their intentions, helping to resolve disputes among beneficiaries. For example, if a will refers to a beneficiary by a nickname, a video could clarify the identity of that person.

Thus, a video will can provide valuable insight into the testator's competence, and intent, and can help to clarify any ambiguities in the written document, thereby aiding courts in upholding the testator's final wishes.

The idea of using video to record a person's last wishes is not new. As early as the 1980s, legal scholars like Gerry W. Beyer began exploring the use of videotape in the probate process. The primary argument in favor of video wills has always been their potential to provide a richer and more personal expression of the testator's intent. A video can capture nuances of tone, emotion, and body language that are absent from a written document, which could theoretically reduce ambiguity and disputes.

Despite their theoretical appeal, standalone video wills have largely failed to gain legal acceptance for several reasons:
Legal Formalities: Most states have strict legal requirements for a will to be considered valid, most notably that it must be in writing and signed by the testator in the presence of witnesses. A video recording does not meet this fundamental “in writing” requirement, making it unenforceable on its own in various jurisdictions with the writing requirement.
Fraud and Tampering: A major concern with video wills is the potential for fraud, manipulation, and tampering. With modern technology, it is easier than ever to alter video and audio recordings, which could undermine the authenticity and integrity of a will.
Lack of Detail and Clarity: A person speaking on camera may not use the precise legal language necessary to create an effective and unambiguous will. This can lead to confusion and disputes among heirs.

Relevant prior art references include the following:
Beyer, Gerry W., and Claire G. Hargrove. “Digital wills: has the time come for wills to join the digital revolution.” Ohio NUL Rev. 33 (2007 ): 865.
Beyer, Gerry W., and William R. Buckley. “Videotape and the Probate Process: The Nexus Grows.” Okla. L. Rev. 42 (1989 ): 43.
Buckley, William R. “Indiana's New Videotaped Wills Statute: Launching Probate into the 21st Century.” Val. UL Rev. 20 (1985 ): 83.
Danet, Brenda, and Bryna Bogoch. “From oral ceremony to written document: the transitional language of Anglo-Saxon wills.” Language & Communication 12, no. 2 (1992 ): 95-122.
Gee, Kyle B. “Electronic wills and the future: When today's techie youth become tomorrow's testators”, www.sssb-law.com/media/1140/chapter_1_gee_electronic_wills_and_the_future_2015_pliskin _2015918.pdf.
Gerry W. Beyer, “Video Requiem: Thy Will Be Done”, 124 Tr. & Est. 24 (1985 ), heinonline.org/HOL/LandingPage? handle=hein.journals/tande124&div=94.

Hirsch, Adam J. “Models of Electronic-Will Legislation.” Real Prop. Tr. & Est. LJ 56 (2021): 163.
Hirsch, Adam J. “Technology adrift: in search of a role for electronic wills.” BCL Rev. 61 (2020 ): 827.
Klasiček, Dubravka. “21st century wills.” Pravni vjesnik: časopis za pravne i društvene znanosti Pravnog fakulteta Sveučilišta Josipa Jurja Strossmayera u Osijeku 35, no. 2 (2019): 29-48.
Komarevceva, Irina A., Marina A. Melnichuk, Olga V. Zhuravleva, Irina S. Shulzhenko, and Galina S. Zakharova. “Development trends of inheritance law in the context of the digital economy.” In Business 4.0 as a Subject of the Digital Economy, pp. 953-957. Cham: Springer International Publishing, 2022.
Lindgren, James. “The fall of formalism.” Alb. L. Rev. 55 (1991 ): 1009.
Marson, Daniel. “Topical issues in contemporaneous assessment of testamentary capacity.” Psychological Injury and Law 15, no. 4 (2022 ): 357-366.
Nunez, Alison V. “A Testament to Inefficacy: Louisiana's New Legislation Allowing for the Admissibility of Videotape Evidence in the Probate Process.” La. L. Rev. 67 (2006): 871.
Pope, Thaddeus Mason. “Video advance directives: Growth and benefits of audiovisual Recording.” SMU L. Rev. 73 (2020 ): 163.
Rzewuski, Maciej. “Electronic will.” University of Warmia and Mazury in Olsztyn, www.wydawnictwo.wsge.edu.pl/pdf-138096-64920?filename=64920.pdf.
Shifrin, Justin. “HB 409, a Drastic Departure from Florida's Traditional Stance on Will Execution Formalities.” J. Tech. L. & Pol'y 24 (2019): 83.
Sneddon, Karen J. “Speaking for the dead: voice in last wills and testaments”, John's L. Rev. 85 (2011 ): 683.
Sonnekus, J. C. “Videotestamente naas skriftelike testamente.” JS Afr. L. (1990): 114.
Załucki, Mariusz. “A few remarks about the future of provisions on making a will contrary to the testamentary formalities law.” Cadernos de dereito actual 13 (2020): 20-31.
Załucki, Mariusz. “Solving The “Problem” Of Wills Formalities In The Modern Post-Pandemic Society: Can The Endless Discussion Be Concluded?.” Studia Iuridica 87 (2021): 526-552.
Załucki, Mariusz. “Testamentary Succession, New Technologies and Recodification: On the Research that Needs to Be Conducted.” Societas Et Iurisprudentia 2, no. 2 (2014).
Zickefoose, Terry. “Videotaped Wills: Ready for Prime Time.” Prob. LJ 9 (1989): 139.

See also: U.S. Pat. Nos. 6,091,835; 6,246,991; 6,938,157; 7,023,979; 7,676,034; 8,073,714; 8,644,466; 9,866,393; 10,110,385; 10,718,031; 11,599,961; 11,816,749; 20020120863; 20040104266; 20060167784; 20070087756; 20070100707; 20070162368; 20070162370; 20070162371; 20070162374; 20070162375; 20070226015; 20080090628; 20080167994; 20080177799; 20080184334; 20100063908; 20100161993; 20100317420; 20110161922; 20110238999; 20110314104; 20140115443; 20150081495; 20160117787; 20170249592; 20180068010; 20180097626; 20180205546; 20180260924; 20190147554; 20190158287; 20200052903; 20200097605; 20200244463; 20200267126; 20200267163; 20200357005; 20200396065; 20210019973; 20210150622; 20210326993; 20210327008; 20220191035; 20220230177; 20220358371; 20220366127; 20220405364; 20230088589; 20230109761; 20230222581; 20230274373; 20230316441; 20230318835; 20230396610; 20240171414; 20240177124; 20240193713; 20240257254; 20240354866; 20240428356; 20250156583; 20250219824; and 20250219825.

### SUMMARY OF THE INVENTION

The present invention solves the foregoing problems by providing an app, application, website or other Internet or Cloud dedicated or shared resource, for use on or with an electronic device, e.g., smart phone, PDA, notebook computer, tablet, desktop, kiosk, etc., by which a testator can easily and securely record and store a video will using the camera and communications functions of or provided for the device. To do so, various technologies described herein are utilized that heretofore have not been combined for such purposes, by which a testator or grantor is prompted to selectively answer a series of questions in order to securely create, record and store an editable video will, trust, deed, or other document which is governed by legal execution formalities.

These include one or more of:
1) encryption and/or digital signature software to prevent the recorded video from being tampered with;
2) use of artificial intelligence (“AI”) to prevent an AI-generated fake video (“deepfake”) will from being created on behalf of the testator, grantor, etc.;
3) use of biometric sensors, e.g., retina scan, voice recognition, etc., to determine if the testator, grantor, etc., is under duress when recording or amending their video will, trust, deed, power of attorney, etc.
4) automated editing to eliminate dead space and any audio, visual or other imperfections in the recorded video;
5) use of automated speech analysis and/or AI to determine the specific elements and choice of law required for a will to be deemed valid in the state where the testator lives, and to ensure that the completed will includes those elements and choice of law;
6) ability for the testator, grantor, etc., to upload identifying information, e.g., driver license, passport, etc., to a verification center for real-time authentication of the testator's, grantor's, or creator's identity;
7) video connection to a notarization/witness center when the testator signs the will, or other document execution, so that a notary and two witnesses can contemporaneously electronically notarize and witness, respectively, while being video recorded, the execution of the will or other legal instrument;
8) cognitive test for the testator, grantor, etc., to ensure that they are competent to make a will or otherwise undertake the effect of the legal instrument;
9) use of biometric sensors, e.g., retina scan, fingerprints, voice recognition, etc., to confirm the identity of the creator and authenticate that the video instrument is being recorded by the device's authorized user, i.e., testator, to prevent an unauthorized user from creating or amending the instrument;
10) voice recognition software to automatically generate a printable hardcopy paper version of the audio portion of the recorded video will or other legal instrument;
11) ability to securely store on a blockchain or distributed ledger a record of the video will or other legal instrument to enable a determination to be made of which version of the will or instrument is the most recent, or if a prior version is revoked, encumbered, or otherwise annotated;
12) ability to securely store the video will or instrument on a server in the cloud where it can be accessed by the testator, grantor or creator (read and write access, optionally limited to change with appropriate formalities) and by authorized beneficiaries (read access only);
13) importing beneficiary contact information into the will from the testator's device's contacts list;
14) use of multi factor authentication (“MFA”) to confirm testator's or grantor's identity when they want to access their stored will or trust to review or amend the same; and
15) use of spoof resistant technology to determine time and location of the recording, such as through Global Navigation Satellite Systems (“GNSS”), e.g., GPS, Gallileo, and/or Glonass.

Any or all of these functions may be performed in real time, or concurrent with recording of the will, or after the recording is made.

Video wills provide several significant advantages compared to conventional hardcopy paper wills. These include enabling the testator's intent to be unambiguously determined as compared to a written document. By means of gestures, facial expressions and vocal inflections made while the video is being recorded, the testator is better able to convey their intent than can be discerned from a hardcopy paper document. Such features of the video may also detect duress. Video wills in which the witnesses and the notary are video recorded also eliminate problems that arise from the absence of witnesses and/or the notary, as for example, during a will contest.

Given the widespread acceptance and use by courts today of electronically filed legal documents, including notarized documents and others made under oath, as well as courts conducting hearings and trials, and allowing depositions, respectively, by video conference, video wills will in the near future be accepted as valid and enforceable legal document in lieu of hardcopy paper wills required today for a will to be deemed valid and enforceable.

Video wills do not necessarily expose greater risk of fraud and tampering than written wills, and may in some cases be less susceptible to fraud and tampering. For example, recordation of a video will (or a digital signature of the recording) on a blockchain can ensure the authenticity of a recording. A subsequent edit or modification of the will (e.g., codicil) may reference the prior will, and as such ensure that notice of the later modification is apparent.

The ownership of the will token (a type of non-fungible token or “NFT”) may be proven using cryptographic techniques. Transfer of ownership of the will (NFT) can be restricted according to a smart contract or other rule, preventing others from obtaining access and/or editing rights. After death of the testator, which may be proven by an official records oracle or other means, the content of the will may be released to a designee, executor, or official, for execution of the will. In some cases, the will itself may be implemented by or in conjunction with a smart contract. For example, the official acts of executor may be performed by providing a cryptographic key or other proof of authority, which will then permit execution of the smart contract. Thus, in a manner of speaking, the NFT representing the will is transferred to the wallet of the executor, and becomes unmodifiable, and with authorization of the executor, the smart contract may then execute.

Even if the will is recorded on a blockchain or distributed ledger, the will itself, and the assets subject to it, may remain off-blockchain, and the legal authority of the executor (and other authorities) may be unrestricted.

The recording is not limited to the legal instrument, and may include extraneous elements or messages with or without legal or evidentiary import. For example, where appropriate, a cognitive or other test of the creator may be recorded with the instrument. Where the capacity of the creator is brought into question, this additional material may serve as evidence of state of mind and capacity of the creator. Similarly, the creator may add surplus discussion to the formal recording, which for example, may help determine state of mind and intent where the formal recording itself is unclear, ambiguous, or silent. Especially where the surplus material is included in the executed and authenticated recording, it may have enhanced legal status.

The implicit presumption that a video will lacks detail and clarity may be addressed and overcome by creating a script for the video will before recording, based on an automated interview through a series of prompts or questions (which may be through a trained professional, artificial intelligence, or treatise-style repository), which are designed to elucidate all of the assets and issues to be addressed, the disposition or resolution of each and every asset and issue, contingencies, residual clauses, compliance with law, tax and legal formalities, and any other relevant issues. The recording may then be transcripted, and the recording and transcript subjected to an analysis by logic or artificial intelligence to both summarize the terms and condition of the instrument, and determine whether the video and transcript correspond to the script or outline that was the basis for recording. Any discrepancies may be resolved in a post-recording editing session, until the video instrument is fully acceptable to the creator and complies with required clarity, detail, formalities and other issues.

It is therefore an object to provide a system for creating or modifying a legal instrument, comprising: a user interface; at least one automated processor; and a memory storing instructions that, when executed by the processor, cause the system to: authenticate and conduct an interrogation of the user to ascertain the user's intent; record a video of the user expressing a set of terms and conditions of the legal instrument according to the interrogation; prompt the user through the user interface to at least one of re-record portions of the video and updating the set of terms and conditions, based on at least one of inconsistencies, incompleteness, and ambiguity between the video and the set of terms and conditions, to produce a complete video; and output information representing the complete video in a manner that is authenticatable with respect to the user and by the updated terms and conditions.

The memory may store further instructions that, when executed by the processor, cause the system to: retrieve a prior version of the legal instrument if exant; and output the information representing the complete video in a manner that is authenticatable with respect to the user, by the updated terms and conditions, and by version of the legal instrument.

The output information representing the complete video may be recorded on a blockchain rendering a content of the output information immutable based on blockchain authentication; and a most current prior version of the legal instrument may be identified based on records in the blockchain.

The memory may store further instructions that, when executed by the processor, cause the system to: administer a cognitive assessment of the user; and record the user during administration of the cognitive assessment.

The legal instrument may be a will, and the memory may store further instructions that, when executed by the processor, cause the system to: generate a written transcript of the complete video representing the updated set of terms and conditions; determine applicable required jurisdictional formalities of execution; and guide the user through execution of the legal instrument according to the applicable required jurisdictional formalities of execution through the user interface.

The memory may further store instructions that, when executed by the processor, cause the system to: interactively determine an inventory of assets of the user; prompt the user, as part of the terms and conditions, to define a disposition of the inventory of assets; and automatically update, independent of the user, at least one asset of the inventory of assets.

The prompt of the user through the user interface to at least one of re-record portions of the video and update the set of terms and conditions, based on at least one of inconsistencies, incompleteness, and ambiguity between the video and the set of terms and conditions, to produce a complete video, may be performed using an artificial intelligence system employing a large language model.

It is also an object to provide a computer-implemented method for creating a legal instrument, comprising: conducting, by an artificial intelligence module, an interactive interrogation of a user to ascertain an intent of the user; administering, by the artificial intelligence module, at least one cognitive assessment of the user; recording a video of the user during the at least one cognitive assessment; and generating, based on the intent of the user, a legal instrument recorded as a video of the user expressing the intent.

The method may further comprise prompting the user to at least one of re-record portions of the video and updating the intent, based on at least one of inconsistencies, incompleteness, and ambiguity between the recorded video and the intent; and outputting the video in a manner that may be authenticatable with respect to the user and a contents of the video.

The method may further comprise retrieving a prior version of the legal instrument if exant; and outputting the video in a manner that may be authenticatable with respect to the user, by the updated terms and conditions, and by a version of the legal instrument.

The method may further comprise recording the video on a blockchain, rendering a content of the video immutable based on blockchain authentication; and identifying a most current prior version of the video based on records in the blockchain.

The legal instrument may be a will, and method may further comprise generating a written transcript of the complete video representing the updated set of terms and conditions; determining applicable required jurisdictional formalities of execution; and guiding the user through execution of the legal instrument according to the applicable required jurisdictional formalities of execution through the user interface.

The method may further comprise determining an inventory of assets of the user; prompting the user to define a disposition of the each asset of the inventory of assets; automatically updating at least one asset of the inventory of assets; and prompting the user to reconsider the disposition of the at least one asset based on the intent and a change in the at least one asset.

The method may further comprise using an artificial intelligence engine to prompt the user to at least one of re-record portions of the video and updating the intent, based on at least one of inconsistencies, incompleteness, and ambiguity between the video and the intent.

It is also an object to provide a non-transitory computer-readable medium storing instructions which are executable by at least one automated processor, comprising: instructions identify, via an interface to a public ledger, a digital asset associated with a user; instructions to prompt the user to define a disposition of the digital asset, via an autonomous smart contract configured to transfer the digital asset to a beneficiary wallet address upon the verification of an off-chain contingency by an oracle; and instructions to prompt the user to update the autonomous smart contract dependent on an automatically-determine change in the digital asset.

The non-transitory computer-readable medium may further comprise instructions to administer a cognitive assessment of the user; and instructions to record a video of the user during administration of the cognitive assessment.

The non-transitory computer-readable medium may further comprise instructions to record a video of the user defining the disposition of the digital asset; instructions to prompt the user to at least one of re-record portions of the video and updating the disposition, based on at least one of inconsistencies, incompleteness, and ambiguity between the video and the disposition; instructions to record authentication information for the video on the public ledger; and instructions to determine a prior version of the video based on the public ledger.

The non-transitory computer-readable medium may further comprise instructions to use an artificial intelligence system to prompt of the user through the user interface to at least one of re-record portions of the video and updating the disposition of the digital asset, based on at least one of inconsistencies, incompleteness, and ambiguity between the video and the disposition.

The non-transitory computer-readable medium may further comprise instructions to generate a written transcript of the video; instructions to determine applicable required jurisdictional formalities of execution to create a legal instrument; and instructions to guide the user through execution of the legal instrument according to the applicable required jurisdictional formalities of execution.

The non-transitory computer-readable medium may further comprise instructions to interactively determine an inventory of assets of the user; instructions to prompt the user to define a disposition of the inventory of assets; and instructions to automatically update, independent of the user, at least one asset of the inventory of assets.

It is also an object to provide a system for creating a testamentary instrument, comprising: a processor; and a memory storing instructions that, when executed by the processor, cause the system to: conduct, via an artificial intelligence (AI) module, an interactive interrogation of a testator to ascertain testamentary intent; administer, via the AI module, at least one cognitive assessment of the testator and record said assessment as first video evidence; generate, based on the ascertained testamentary intent, a text-based testamentary instrument; and assemble a final evidentiary package comprising at least the testamentary instrument and the first video evidence of the cognitive assessment.

It is a further object to provide a computer-implemented method for creating a testamentary instrument, comprising: conducting, by an artificial intelligence (AI) module, an interactive interrogation of a testator to ascertain testamentary intent; administering, by the AI module, at least one cognitive assessment of the testator; recording the at least one cognitive assessment as video evidence; and generating, based on the ascertained testamentary intent, a text-based testamentary instrument that may be cryptographically linked to the video evidence.

Another object provides a non-transitory computer-readable medium storing instructions which, when executed by a processor, cause the processor to perform a method comprising: conducting an interactive interrogation of a testator via an artificial intelligence (AI) module to determine testamentary intent; administering and recording a cognitive assessment of the testator as video evidence to establish testamentary capacity; and generating a testamentary instrument based on the determined testamentary intent, wherein the instrument may be associated with the video evidence.

A further object provides a system for generating a testamentary instrument, comprising: a processor; and a memory storing instructions that, when executed by the processor, cause the system to: identify, via an interface to a public ledger, a digital asset associated with a testator; generate an autonomous smart contract configured to transfer the digital asset to a beneficiary wallet address upon the verification of an off-chain contingency by a decentralized oracle service; and generate a testamentary instrument that includes a disclosure of the autonomous transfer of the digital asset.

Another object provides a computer-implemented method for disposing of digital assets, comprising: identifying a digital asset controlled by a testator; generating, by a computer system, an autonomous smart contract configured to transfer the digital asset to a beneficiary upon verification of a contingency by a decentralized oracle service, said transfer occurring without requiring intervention by an executor; and deploying the autonomous smart contract to a blockchain.

A still further object provides a non-transitory computer-readable medium storing instructions which, when executed by a processor, cause the processor to perform a method comprising: identifying a digital asset associated with a testator; generating an autonomous smart contract configured to transfer the digital asset upon verification of an off-chain event by an oracle, e.g., death of the testator; and facilitating the deployment of the autonomous smart contract to a distributed ledger.

Another object provides a system for creating a verifiable testamentary instrument, comprising: a processor; and a memory storing instructions that, when executed by the processor, cause the system to: generate a testamentary instrument; facilitate a remote electronic execution ceremony of the testamentary instrument, wherein the ceremony may be recorded as video evidence; and record a cryptographic hash of an evidentiary package, the package comprising at least the executed testamentary instrument and the video evidence of the execution ceremony, on a distributed ledger.

A further object provides a computer-implemented method for creating a verifiable testamentary instrument, comprising: generating a testamentary instrument based on a testator's intent; recording a remote electronic execution ceremony for the testamentary instrument as video evidence; and storing, on a distributed ledger, a cryptographic hash derived from at least the executed testamentary instrument and the video evidence, thereby creating a tamper-evident record.

A still further object provides a non-transitory computer-readable medium storing instructions which, when executed by a processor, cause the processor to perform a method comprising: facilitating a remote electronic execution ceremony for a testamentary instrument; recording the execution ceremony as video evidence; and causing a cryptographic hash of the executed testamentary instrument and the video evidence to be recorded on a blockchain.

Another object provides a system for secure storage of a testamentary instrument, comprising: a processor; and a memory storing instructions that, when executed by the processor, cause the system to: encrypt a testamentary instrument package using a symmetric encryption key; asymmetrically encrypt the symmetric encryption key using a public key of at least one authorized user, thereby creating an encrypted key; and deploy a key distribution smart contract to a distributed ledger, said smart contract configured to release the encrypted key only to the corresponding authorized user.

A further object provides a computer-implemented method for providing confidential access to a testamentary instrument, comprising: encrypting a data package containing a testamentary instrument with a symmetric key; encrypting the symmetric key with a public key of an authorized user to create an encrypted access key; and storing the encrypted access key in a smart contract on a distributed ledger, wherein the smart contract may be configured to release the encrypted access key upon authentication of the authorized user.

A still further object provides a non-transitory computer-readable medium storing instructions which, when executed by a processor, cause the processor to perform a method comprising: encrypting a testamentary instrument package with a first key; encrypting the first key with a public key of an authorized user to create a second key; and associating the second key with the authorized user in a smart contract deployed to a distributed ledger.

Another object provides a system for creating a testamentary instrument, comprising: a processor; and a memory storing instructions that, when executed by the processor, cause the system to: conduct, via an artificial intelligence (AI) module, an interactive interrogation of a testator to ascertain testamentary intent regarding assets and beneficiaries; administer, via the AI module, at least one cognitive assessment of the testator and record said assessment as first video evidence; generate, via the AI module, a draft text-based testamentary instrument based on the ascertained testamentary intent; facilitate a remote electronic execution ceremony of the testamentary instrument, wherein said ceremony may be recorded as second video evidence; and assemble a final evidentiary package comprising at least the executed testamentary instrument, the first video evidence of the cognitive assessment, and the second video evidence of the execution ceremony.

The instructions may further cause the system to record a cryptographic hash of the final evidentiary package on a distributed ledger.

The AI module may be further configured to analyze at least one of vocal biomarkers and facial expressions from the first video evidence to generate a quantitative or qualitative score of testamentary capacity.

The at least one cognitive assessment may comprises a plurality of tests administered at different stages of the creation process, the plurality of tests including a baseline assessment administered prior to the interactive interrogation and a document comprehension assessment administered after the generation of the draft text-based testamentary instrument.

The instructions may further cause the system to: generate, via the AI module, at least one smart contract for the disposition of a digital asset identified during the interactive interrogation.

The at least one smart contract may be an autonomous contract configured to transfer the digital asset upon verification of a contingency by a decentralized oracle service, said transfer occurring without requiring intervention by an executor.

The contingency may be one of death or legal disability, and wherein the verification of legal disability by the oracle service requires a quorum of cryptographic attestations from a plurality of pre-authorized entities.

The at least one smart contract may be a testamentary contract configured to transfer the digital asset only upon receiving a cryptographic signature from an executor authorized under the testamentary instrument.

The draft text-based testamentary instrument may be assembled from a library of jurisdiction-specific coded paragraphs, each paragraph having a unique identifier. Upon modification of a coded paragraph by the testator, the instructions may further cause the system to automatically generate a redline comparison against an original version of the coded paragraph and a legal issue analysis report based on the modification.

The instructions may further cause the system to: encrypt the final evidentiary package using a symmetric encryption key; asymmetrically encrypt the symmetric encryption key for each of a plurality of authorized users identified by a wallet address, thereby creating a plurality of encrypted keys; and deploy a key distribution smart contract to a distributed ledger, said smart contract containing the plurality of encrypted keys and configured to release a specific encrypted key only to a corresponding authorized user.

It is also an object to provide a method for creating a legally enforceable testamentary instrument, the method comprising: conducting, by a computer system executing an artificial intelligence (AI) module, an interactive interrogation of a testator to ascertain testamentary intent; administering, by the AI module, a plurality of cognitive assessments of the testator at different stages of the creation process, and recording said assessments as video evidence; generating, by the AI module, a draft text-based testamentary instrument based on the ascertained testamentary intent, wherein the instrument may be assembled from a library of jurisdiction-specific coded paragraphs; analyzing, by the AI module, the draft instrument for internal inconsistencies; facilitating, by the computer system, a remote electronic execution ceremony wherein the instrument may be electronically signed by the testator and at least two witnesses; assembling, by the computer system, a final evidentiary package comprising at least the executed testamentary instrument and the video evidence of the plurality of cognitive assessments; and recording, by the computer system, a cryptographic hash of the final evidentiary package on a distributed ledger.

The method may further comprise analyzing, by the AI module, at least one of vocal biomarkers and facial expressions from the video evidence to generate a capacity score for the testator.

The method may further comprise identifying, by the AI module, a digital asset controlled by the testator; and generating, by the AI module, an autonomous smart contract configured to transfer the digital asset to a beneficiary upon the verification of a contingency by a decentralized oracle service.

The contingency may be the legal disability of the testator, and the verification may require the oracle service to receive a quorum of cryptographic attestations from a plurality of pre-authorized medical or legal entities.

The method may further comprise detecting a modification to one of the coded paragraphs by the testator; and in response to the modification, automatically generating a redline comparison and a report on potential legal issues arising from the modification.

The draft text-based testamentary instrument may establish a special needs trust for a beneficiary, and wherein administering the cognitive assessments includes a document comprehension test wherein the testator may be prompted to explain the restrictive distribution standards of said trust.

The draft text-based testamentary instrument may be a codicil, the method further comprising: retrieving a previously executed testamentary instrument using a hash stored on the distributed ledger; and cryptographically linking the executed codicil to the previously executed instrument.

It is also an object to provide a system for creating a legally enforceable testamentary instrument, the system comprising: a processor; and a memory storing instructions that, when executed by the processor, cause the system to: conduct, via an artificial intelligence (AI) module, an interactive interrogation of a testator to ascertain testamentary intent; generate, via the AI module, a draft text-based testamentary instrument based on the ascertained testamentary intent; generate, via the AI module, at least one autonomous smart contract configured to transfer a digital asset to a beneficiary wallet address upon the verification of an off-chain contingency by a decentralized oracle service; facilitate a remote electronic execution of the testamentary instrument; and deploy the at least one autonomous smart contract to a blockchain upon the execution of the testamentary instrument.

The instructions further cause the system to administer and record a plurality of cognitive assessments of the testator; and assemble a testamentary capacity evidence package comprising video recordings of the assessments, wherein said package may be cryptographically linked to the executed testamentary instrument.

Another object provides a system for making a video will using an app comprising: at least one first memory configured to store questions which are answered by a testator to create a template for a will, and at least one second memory configured to store a recording of a video of the will based on the template.

The system may further comprise encryption and/or digital signature software to prevent the recorded video of the will from being tampered with.

The system may further comprise artificial intelligence software configured to at least one of detect and prevent an inauthentic or unverified video of the will created on behalf of a testator.

The system may further comprise at least one biometric sensor configured to determine if a testator may be under duress when recording or amending the video of the will.

The system may further comprise automated editing software configured to skip dead space or pauses in the recorded video will, while preserving the skipped spaces or pauses for authentication purposes.

The system may further comprise automated editing software configured to identify and correct imperfections in the recorded video will, while maintaining an audit trail of the corrected imperfection

The system may further comprise artificial intelligence software configured to determine specific elements required by applicable law for the recorded video of the will to be deemed valid.

The system may further comprise a geolocation receiver configured to determine a location of the testator during recording of the video will.

The system may further comprise a geolocation receiver configured to determine a time of recording of the video will.

The system may further comprise a communication module configured to communicate with an authenticated server and retrieve information defining the applicable law for the recorded video will.

The system may further comprise an input configured to receive information defining a legal jurisdiction governing the video will.

The system may further comprise an input configured to receive information defining a plurality of relevant legal jurisdictions applicable to the video will; and an artificial intelligence module configured to determine a consistent set of provisions for the recorded video will that comply with the laws of the plurality of relevant legal jurisdictions applicable to the video will.

The system may further comprise an artificial intelligence module configured to determine whether a completed recording of the video will complies with applicable law applied to enforcement and administration of the recorded video will.

The system may further comprise an input configured to receive information identifying the state where a testator lives as a choice of law; an interface to a database of law of the state where the testator lives defining an applicable set of laws, required elements, and prohibited elements; and a software module configured to apply the applicable laws of the state where the testator lives to ensure that the completed recording of the video will complies with the applicable set of laws, includes all required elements, excludes the prohibited elements, and includes a choice of law comprising the state where the testator lives.

The system may further comprise at least one input configured to receive identifying information of the testator; and at least one communication interface configured to upload the identifying information to a verification center, to authenticate a testator's identity.

The system may further comprise a video connection interface configured to communicate a live video stream of the testator to a notarization/witness center when a testator executes the recording of the video will, so that a notary can contemporaneously electronically notarize, and witnesses can contemporaneously electronically witness, the execution of the recording of the video will.

The system may further comprise at least one software module configured to perform and record video of cognitive testing to ensure that a testator may be competent to make an enforceable will.

The system may further comprise at least one biometric sensor configured to confirm an identity of a testator; and an authentication module configured to confirm that that a device being used to make the recording of the video will may be the testator's device, to prevent an unauthorized user from creating or amending the recording of the video will.

The system may further comprise speech recognition software configured to automatically generate a transcript version of an audio portion of the recording of the video will.

The system may further comprise voice recognition software configured to automatically authenticate the a testator based on voice patterns of an audio portion of the recording of the video will.

The system may further comprise a communication interface to a distributed ledger system configured to securely store on the distributed ledger system a record of the recording of the video will, to enable a determination to be made of which version of the will may be the most recent.

The distributed ledger system may comprise a blockchain.

The record may comprise the recording of the video will.

The record may comprise an digital signature or hash digest of the recording of the video will.

The record may be associated with a smart contract having executable code.

The record may be associated with at least one digital token which represents at least one right granted in the will. The token may be transferrable in a market. The token may be a non-fungible token. The token may be a fungible token.

The system may further comprise a server configured to securely store the recording of the video will, where it can be accessed for viewing and editing by a testator and for viewing only by authorized persons or entities. The server may be hosted in a cloud.

The will may identify authorized persons or entities.

The system may further comprise a contact list interface configured to receive an import of beneficiary contact information from a smartphone.

The system may further comprise at least two distinct communication interfaces configured to support multi factor authentication, to confirm a testator's identity.

The system may further comprise a module configured to detect an attempt to spoof a Global Navigation Satellite Systems signal.

The module may be configured to resist an attempt to modify at least one of a time and a location of the recording of the video will.

It is another object to provide a method for making a video will using an app comprising: answering questions to create a will, and recording a video of the will being read.

The method may further comprise using software to prevent the recorded video from being tampered with.

The method may further comprise using artificial intelligence to prevent a fake video will from being created on behalf of a testator.

The method may further comprise using biometric sensors to determine if a testator may be under duress when recording or amending their video will.

The method may further comprise automatically editing the recorded video to eliminate dead space and any audio, visual or other imperfections.

The method may further comprise using artificial intelligence to determine the specific elements required for a will to be deemed valid in a state where a testator lives, and to ensure that the completed recording of the video will includes those elements and a choice of law of the state where the testator lives.

The method may further comprise uploading identifying information to a verification center to authenticate a testator's identity.

The method may further comprise using a video connection to a notarization/witness center when a testator signs the will, so that a notary and witnesses can contemporaneously electronically notarize and witness, respectively, while being video recorded, the execution of the recording of the video will.

The method may further comprise administering a cognitive test to a testator to ensure that they are competent to make a will.

The method may further comprise using biometric sensors to confirm the identity of a testator and to authenticate that the device being used to make the recording of the video will may be the testator's device, to prevent an unauthorized user from creating or amending the will.

The method may further comprise using speech recognition software to automatically generate a printable hardcopy paper version of an audio portion of the recording of the video will.

The method may further comprise securely storing on a blockchain a record of the recording of the video will, to enable a determination to be made of a most recent version of testator's will.

The method may further comprise securely storing the video will on a server in the cloud where it can be accessed for viewing and editing by a testator and for viewing only by authorized beneficiaries.

The method may further comprise importing beneficiary contact information into the will from a testator's device's contacts list.

The method may further comprise using multi factor authentication to confirm a testator's identity to authenticate access to a stored recording of the video will.

The method may further comprise using a spoof resistant technology to determine a time and a location of the recording of the video will through a Global Navigation Satellite System.

### BRIEF DESCRIPTION OF THE DRAWINGS

FIG. 1 shows a block diagram of a first embodiment of the present invention.

FIG. 2A shows a block diagram of a second embodiment of the present invention.

FIGS. 2B-2E show pseudocode associated with the second embodiment of the present invention.

FIG. 3A shows a block diagram of a third embodiment of the present invention.

FIG. 3B shows pseudocode associated with the third embodiment of the present invention.

FIG. 4A shows a block diagram of a fourth embodiment of the present invention.

FIG. 4B shows pseudocode associated with the fourth embodiment of the present invention.

FIG. 5 shows a block diagram of a fifth embodiment of the present invention.

FIG. 6A shows a block diagram of a sixth embodiment of the present invention.

FIG. 6B shows pseudocode associated with the sixth embodiment of the present invention.

FIG. 7A shows a block diagram of a seventh embodiment of the present invention.

FIG. 7B shows pseudocode associated with the seventh embodiment of the present invention.

FIG. 8 shows a block diagram of a eighth embodiment of the present invention.

FIGS. 9A and 9B shows block diagrams of aspects of a ninth embodiment of the present invention.

FIG. 10 shows a block diagram of a tenth embodiment of the present invention.

FIG. 11 shows a block diagram of a eleventh embodiment of the present invention.

FIG. 12 shows a block diagram of a twelfth embodiment of the present invention.

FIG. 13 shows a block diagram of a thirteenth embodiment of the present invention.

FIG. 14 shows a block diagram of a fourteenth embodiment of the present invention.

### DESCRIPTION OF THE INVENTION

### Example 1

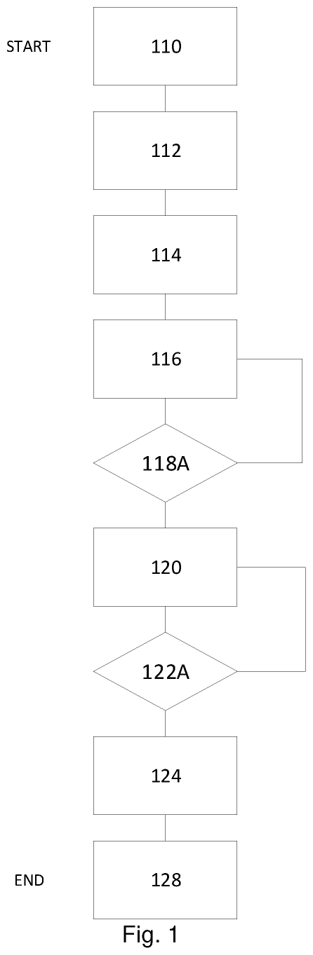

FIG. 1 shows a block diagram of an exemplary embodiment of the present invention that is directed to a new system and method of creating a will by making a video and audio (e.g., multimedia) recording of the testator reading their will, instead of merely generating a hardcopy paper document. More specifically, FIG. 1 shows the steps of a method for creating a video will, according to the present invention, as described below.

At step 10, a testator downloads the app onto their device. (In other embodiments, the app or code may already be present, the code execute remotely, or the code is bespoke and generated ad hoc).

At step 12, the testator opens the app (or otherwise initiates execution) and is provided with: instructions on how to use the app or interface; and prompts to authenticate and verify their identity, and to create, record, edit, finalize, witness, notarize, store and amend, respectively, the recorded video will. The system may be controlled by verbal commands and/or by using the keyboard and/or graphic user interface of the testator's device to select specific features, answer questions and respond to prompts to effectuate the video will. The questions can be presented in various formats including, but not limited to, yes/no, fill-in-the-blank, multiple choice, etc. Other ways to interact with the system to define the testator's intent is by conducting a personal or automated interview with the testator, interactive voice response (IVR), text messaging, videoconference, email, or other manual or automated interactive communication. Typically, the will is not defined in a single prompt or input, and rather the issues are dissected and investigated until completeness and comprehensiveness is achieved.

For example, a testator may receive various correspondence over time, relating to various assets. As the correspondence is received, the testator may inventory such assets in the system, through sporadic inputs. A testator may further review files in a file cabinet or record storage. An artificial intelligence agent may index an email archive to identify subject assets, liabilities and records in one or more email accounts. As a means of inventorying the assets, liabilities and other issues, persons other than the testator may be queried, such as spouse or other relatives, financial manager, etc., to ensure that the inventory is complete.

Advantageously, the app or system may be used as an asset and account manager, independent of the will or other legal instrument. The assets may be analyzed over time, so that as presumptions underlying the will change, the testator is promoted to consider amending the will or creating a codicil to conform the will with the then current conditions. For example if the testator intends to make a bequest and selects certain holdings to satisfy that bequest, and the value of the holdings changes significantly, the testator may be promoted to consider updating the bequest based on the current status.

The app may include various security features including: an authentication feature that allows the testator to upload identifying information, e.g., driver license, passport, etc., to a verification center for real-time authentication of the testator's identity; and real-time use of the device's biometric sensors, e.g., retina scan, fingerprints, voice recognition, etc., to confirm the identity of the testator and authenticate that the video will is being recorded by the device's authorized user, i.e., testator, to prevent an unauthorized user from creating or modifying the will. In some cases, a DNA sample or other biological specimen is obtained from the testator. Additional security features may include: the use of encryption software to prevent the recorded video from being hacked; real-time use of AI to prevent an AI-generated fake video will from being created on behalf of the testator; and real-time use of the device's biometric sensors, e.g., retina scan, voice recognition, etc., to determine if the testator is under duress when recording or amending their video will. The time and location of the recording may be determined from GNSS signals received by the user's device, and as necessary, a geofence technology used to ensure that the system is not used where prohibited or the result would be invalid. The recording may be verified with digital hash values which prevent tampering, and the final result may be signed using a digital signature of the testator.

In order to prevent spoofing (inserting false information) GPS and/or time information in the record, a copy of the video will, or a hash digest (csrc.nist.gov/glossary/term/hash_digest) of the recording, or even frames or portions of the recording, are recorded on a blockchain. Therefore, based on the time of the block, it is established that the hash (and therefore the underlying information) had to preexist the block, establishing a latest time of creation. In addition, the GPS Y-code (see, www.csr.utexas.edu/texas_pwv/midterm/gabor/gps.html; en.wikipedia.org/wiki/GPS_signals) even without decryption may be recorded or a hash digest created, and stored in the block. Since the Y-code is encrypted with a secret key, the value is not known until it is first broadcast. Therefore, the Y-code sets an earliest time of recording of the information. Together, this information establishes a margin of the time required to record the information on an accepted block as the time range of the recording.

The location may be established by, for example, employing network-based location augmentation. See:
Camenisch, Jan, Diego Alejandro Ortiz-Yepes, and Franz-Stefan Preiss. “Strengthening authentication with privacy-preserving location verification of mobile phones.” In Proceedings of the 14th ACM Workshop on Privacy in the Electronic Society, pp. 37-48. 2015.doi.org/10.1145/2808138.2808144.
Amir Haleem, Andrew Allen, Andrew Thompson, Marc Nijdam, Rahul Garg, “Helium: A Decentralized Wireless Network”, Helium Systems, Inc., Release 0.4.2 (2018 -11-14). whitepaper.helium.com/
Becker, Georg T., Sherman C. Lo, David S. De Lorenzo, Per K. Enge, and Christof Paar. “Secure location verification: a security analysis of GPS signal authentication.” In Data and Applications Security and Privacy XXIV: 24th Annual IFIP WG 11.3 Working Conference, Rome, Italy, Jun. 21-23, 2010. Proceedings 24, pp. 366-373. Springer Berlin Heidelberg, 2010., inria.hal.science/file/index/docid/1056742/filename/_18.pdf
Becker, Georg T., Sherman C. Lo, David S. De Lorenzo, Per K. Enge, and Christof Paar. “Secure location verification: a security analysis of GPS signal authentication.” In Data and Applications Security and Privacy XXIV: 24th Annual IFIP WG 11.3 Working Conference, Rome, Italy, Jun. 21-23, 2010. Proceedings 24, pp. 366-373. Springer Berlin Heidelberg, 2010. http://library.usc.edu.ph/ACM/SIGSAC%202017/cps-spc/p35.pdf

The app also includes features to ensure that the testator is competent and that the recorded will is valid including: a cognitive test administered on the testator's device using a real-time video connection to a testing center to determine whether the testator is legally competent to make a will; real-time use of AI to determine the specific elements and choice of law required for a will to be valid in the state where the testator lives and that the completed will includes those elements and choice of law; and use of a real-time video connection to a notarization/witness center when testator signs the will so that a notary and two witnesses can contemporaneously electronically notarize and witness, respectively, while they are being video recorded, the testator's execution of the will. The verification center, the testing center, and the notarization/witness center can be implemented using a single server or multiple servers, and a single software program or multiple software programs can be utilized to implement the requisite functionality of these features. Alternatively, the notarization/witness center can employ AI generated notaries and witnesses.

The video will, or a hash digest of the will, may be recorded on a blockchain or distributed ledger system. A token representing the video may be used to “possess” the will. In some cases, a bequest under a will may be tokenized and granted to a beneficiary as a marketable or tradeable asset representing a contingent or future interest in the estate of the testator. Smart contracts may also be employed to execute logic or contingencies in accordance with the wishes (will) of the testator. In some cases, the smart contract may represent a present transfer of the future interest, and thus bypass testamentary laws. In other cases, the smart contract may be explicitly subject to testamentary laws.

At step 114 the testator selects the start option to begin creating their will. The app prompts the testator to answer a series of questions including their name and address: street, town and state, and the names of beneficiaries and any executors. The testator can selectively skip and omit answering questions that are not applicable to their personal circumstances. For example, if a question asks the testator to identify specific bequests of possessions to be made and the beneficiaries of such bequests, the testator need not answer that question if they are not making any such bequests.

Once the testator answers all the questions, at step 116 the app will use AI such as generative pre-trained transformer (“GPT”) and/or large language models (“LLM”, see en.wikipedia.org/wiki/Large_language_model) (e.g., ChatGPT, Grok, Gemini, CoPilot, Claude), to assemble the answers into an electronic legal document viewable on the screen of the testator's device that they can review and/or edit to ensure that all the requisite information necessary to convey their wishes has been provided and is correct.

If satisfied with the answers they provided, at step 118A the testator finalizes the will. If not, then at step 118B, the testator can elect to edit the answers and are then returned to step 116 to rerecord the entirety or selected portions of the answers which are then assembled into an electronic legal document viewable on the screen of their device for review and further editing if necessary.

If at step 118A the testator elects to finalize the will, then at step 120 they can elect to record a video including audio of themselves reading the finalized document.

If satisfied with the video they recorded, then at step 122A the testator finalizes the recorded video will. If not, then at step 122B, the testator can elect to edit the recorded video and are then returned to step 120 to edit and/or rerecord the entirety or any selected portions of the video with which they are dissatisfied before electing that they deem the video legal document to be finished.

If at step 122A the testator elects to finalize the recorded video will, then at step 124 they can elect to execute the will themselves electronically and have the will notarized and witnessed via a real-time video connection to the notarization/witness center.

At step 126, the testator can elect to securely store a copy of the fully executed version of the video will on a server in the cloud. The testator can also elect to store the recorded will on their device. The stored video is readily accessible by the testator when desired for viewing or amendment.

At step 128, the testator can elect to have a record of the recorded video will (or an immutable identifier of the will) stored on the blockchain.

The technology is also directed to a system for making a video will comprising an app having at least one first memory configured to store questions which are answered by a testator to create a template for a will, and at least one second memory configured to store a recording of a video of the will based on the template.

After all or a portion or segment of the video will is recorded, that portion may be analyzed according to the inputs and governing laws and rules. The video will is typically subjected to a speech-to-text conversion, and that converted document used as part of the analysis. Because of performance issues, both the video and the transcript are analyzed, to ensure that they represent the testators intent, comply with law and rules, and otherwise are appropriate. If there is a deviation, a determination is made whether the video recording needs to be re-recorded, or whether the script or paradigm deviates from the testator's intent. In any case, the issues are resolved by a feedback system that reconciles the recording with the goal. After the entire instrument is recorded, it is again analyzed holistically for completeness, correctness, and correspondence to the defined scope, and the feedback loop of analysis and correction of the recording and/or modification of the scope is used to finalize the recording.

In some cases, the legal instrument is the transcript, and the recording is made for extralegal purposes. In such cases, artificial intelligence and generative AI may be used to edit or modify the video for aesthetic or other purposes. Where legal restrictions would prohibit or discourage such modifications, the live video is typically encoded with anti-tampering codes in each frame or series of frames.

The system may further comprise: encryption and/or digital signature software to prevent the recorded video of the will from being tampered with; artificial intelligence software configured to at least one of detect and prevent an inauthentic or unverified video of the will created on behalf of a testator; at least one biometric sensors configured to determine if a testator is under duress when recording or amending the video of the will; automated editing software configured to skip dead space or pauses in the recorded video will, while preserving the skipped spaces or pauses for authentication purposes; and automated editing software configured to identify and correct imperfections in the recorded video will, while maintaining an audit trail of the corrected imperfections.

The system may further comprise artificial intelligence software configured to determine specific elements required by applicable law for the recorded video of the will to be deemed valid, wherein: a geolocation receiver configured to determine a location of the testator during recording of the video will; a geolocation receiver configured to determine a time of recording of the video will; and a communication module configured to communicate with an authenticated server, and retrieve information defining the applicable law for the recorded video will.

The system may further comprise an input configured to receive information defining a legal jurisdiction governing the video will; an input configured to receive information defining a plurality of relevant legal jurisdictions applicable to the video will, and an artificial intelligence module configured to determine a consistent set of provisions for the recorded video will that comply with the laws of the plurality of relevant legal jurisdictions applicable to the video will; and an artificial intelligence module configured to determine whether a completed recording of the video will complies with applicable law applied to enforcement and administration of the recorded video will.

The system may further comprise an input configured to receive information identifying the state where a testator lives as a choice of law; an interface to a database of law of the state where the testator lives defining an applicable set of laws, required elements, and prohibited elements; and a software module configured to apply the applicable laws of the state where the testator lives to ensure that the completed recording of the video will complies with the applicable set of laws, includes all required elements, excludes the prohibited elements, and includes a choice of law comprising the state where the testator lives.

The system may further comprise at least one input configured to receive identifying information of the testator, and at least one communication interface configured to upload the identifying information to a verification center, to authenticate a testator's identity; a video connection interface configured to communicate a live video stream of the testator to a notarization/witness center when a testator executes the recording of the video will, so that a notary can contemporaneously electronically notarize, and witnesses can contemporaneously electronically witness, the execution of the recording of the video will; and at least one software module configured to perform and record video of cognitive testing to ensure that a testator is competent to make an enforceable will.

The system may further comprise at least one biometric sensor configured to confirm an identity of a testator, and an authentication module configured to confirm that that a device being used to make the recording of the video will is the testator's device, to prevent an unauthorized user from creating or amending the recording of the video will; speech recognition software configured to automatically generate a transcript version of an audio portion of the recording of the video will; and voice recognition software configured to automatically authenticate the a testator based on voice patterns of an audio portion of the recording of the video will.

The system may further comprise a communication interface to a distributed ledger system configured to securely store on the distributed ledger system a record of the recording of the video will, to enable a determination to be made of which version of the will is the most recent, wherein: the distributed ledger system comprises a blockchain; the record comprises the recording of the video will; the record comprises an digital signature or hash digest of the recording of the video will; the record is associated with a smart contract having executable code; and the record is associated with at least one digital token which represents at least one right granted in the will, wherein the token is transferrable in a market, and the token is a non-fungible token and/or a fungible token.

The system may further comprise a server configured to securely store the recording of the video will, where it can be accessed for viewing and editing by a testator and for viewing only by authorized persons or entities, wherein: the server is hosted in the cloud, and the will identifies authorized persons or entities; a contact list interface configured to receive an import of beneficiary contact information from a smartphone: at least two distinct communication interfaces configured to support multi factor authentication, to confirm a testator's identity; and a module configured to detect an attempt to spoof a Global Navigation Satellite Systems signal, wherein the module is configured to resist an attempt to modify at least one of a time and a location of the recording of the video will

The technology can be monetized by charging testators a one-time fee to download the app. Additional and recurring fees, e.g., per transaction or monthly, can also be charged to edit the video, to securely store the video on a server in the cloud, to store a record of the video on the blockchain. Additional fees can also be charged to have a testator's execution of their video will witnessed and notarized, and to notify the beneficiaries of the existence of and provide them with read only access to the recorded video will. Various optional features or services may be charged incrementally.

The technology may also include the ability for a testator to personalize their video will by uploading and including other files, e.g., documents, personal video messages, photographs, etc., they wish to include as part of their will.

### Example 2

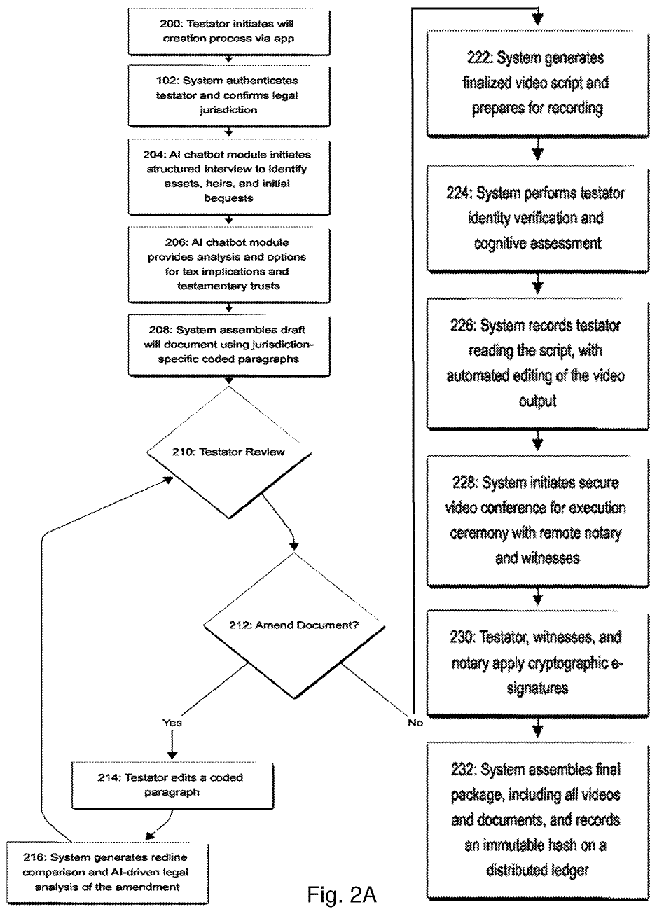

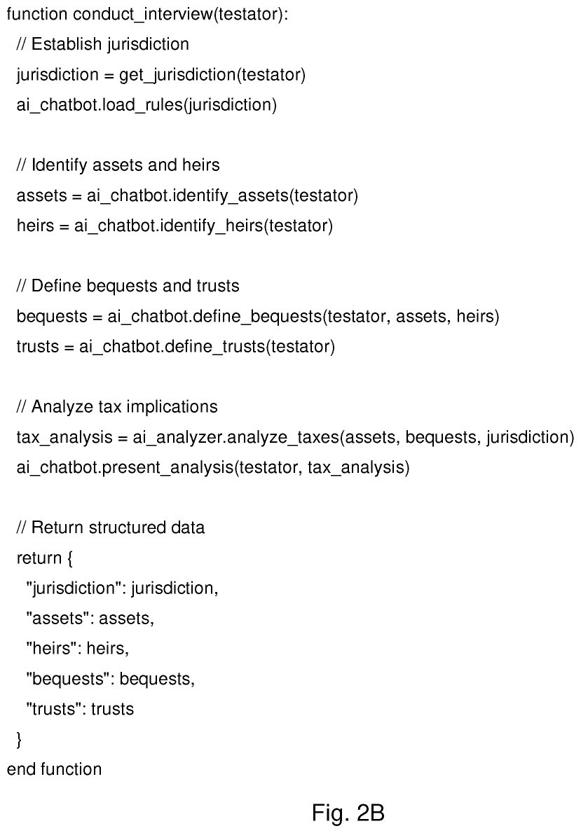

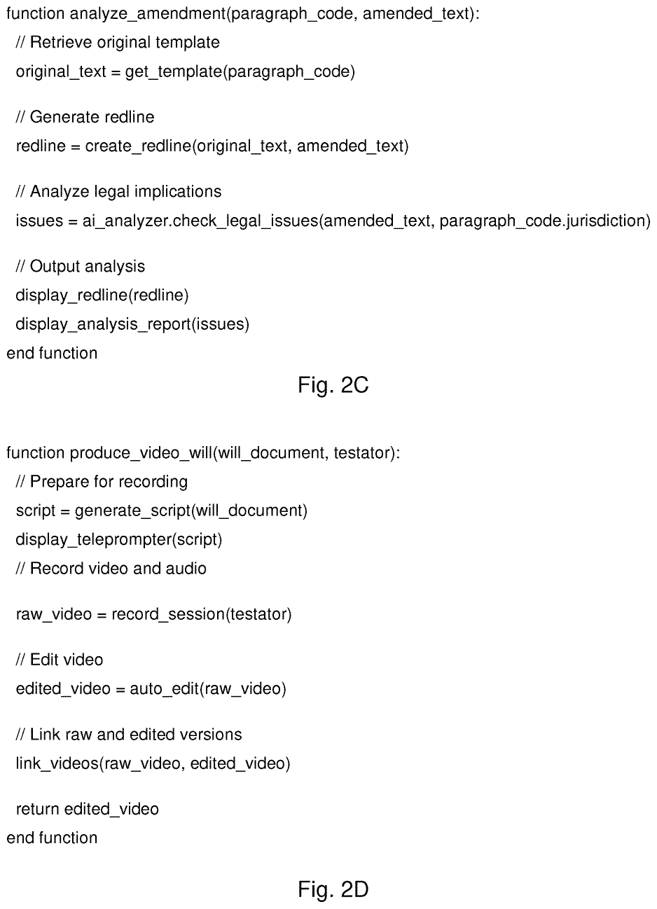

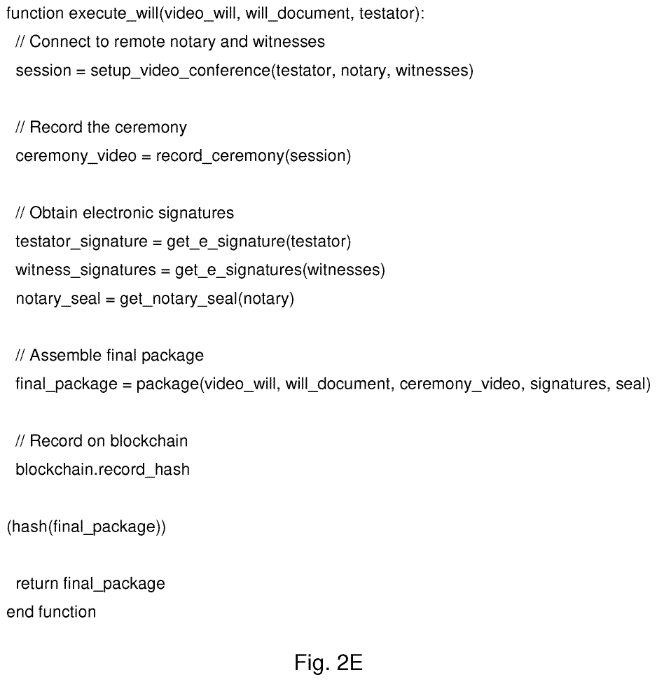

FIG. 2A shows a flowchart illustrating an exemplary embodiment of the method. The numbered boxes correspond to the steps detailed in the subsequent example. The flowchart represents a description of an exemplary embodiment of the technology. A testator, a 65-year-old resident of New York, utilizes the disclosed system via an application on a personal electronic device to create a legally enforceable video will.

Initiation and Authentication (200): The process is initiated when the testator launches the application. The system first performs an authentication sequence, which may include multi-factor authentication, to verify the testator's identity.

Jurisdiction Establishment (202): Upon successful authentication, the system prompts the testator to confirm their primary state of residence. The testator confirms “New York,” and the system's AI module, hereinafter referred to as the AI chatbot, loads the legal rules, statutes, best practices, and paragraph templates specific to New York estate law.

AI-Driven Interrogation (204): The AI chatbot initiates a structured interrogation process to ascertain the testator's intent and to catalog all necessary information. This interrogation proceeds through several modules. An asset identification module prompts the testator to enumerate all significant assets, including real property, financial accounts, and tangible personal property. An heir identification module prompts the testator to list all potential heirs and beneficiaries, with clarifying questions designed to prevent pretermitted heir disputes in accordance with New York law.

Advanced Legal Analysis (206): The interrogation continues to more complex subjects. Based on the cataloged assets, an AI tax analysis module calculates potential federal and New York state estate tax liabilities. It presents this analysis to the testator in a comprehensible format and proposes strategies for tax mitigation, such as the creation of one or more testamentary trusts. The AI chatbot explains the function of a testamentary trust, the role of a trustee, and the benefits for the beneficiaries. The testator elects to create a trust, and the system incorporates this decision.

The logic for this interrogation and analysis phase is implemented as shown in FIG. 2B

Document Assembly with Coded Paragraphs (208): Upon completion of the interview, a document assembly module generates a draft will. This module utilizes a library of jurisdiction-specific, attorney-vetted “coded paragraphs.” Each paragraph or clause is assigned a unique alphanumeric identifier (e.g., NY-TRUST-001, NY-BEQ-RPROP-002) that signifies its jurisdiction, function, and content. This coding facilitates rapid and accurate review by a legal professional.

Testator Review and Amendment (210, 212, 214): The testator reviews the drafted document. Should the testator wish to amend a provision, they may edit the text of a coded paragraph directly within the application interface.

Automated Redlining and Amendment Analysis (216): Upon detecting a modification to a coded paragraph, the system performs two automated functions. First, a redline comparison is generated, visually showing the deviation from the approved template. Second, an AI analysis module examines the amended text for potential legal issues, such as the introduction of ambiguity, unenforceable conditions, or conflicts with state law. The system generates a report detailing these issues and may suggest alternative language.

The logic for this amendment analysis is implemented as shown in FIG. 2C.

Automated Inconsistency Analysis (218): After the testator finalizes all edits, the system executes a global inconsistency analysis. The AI module cross-references every provision in the document to identify internal contradictions. For example, it verifies that an asset bequeathed in one clause is not also directed into a trust in another. This analysis is jurisdiction-dependent, checking for violations of specific legal doctrines applicable in New York.

Compilation for Professional Review (220): The system compiles a package for optional review by a legal professional. This package includes the final draft of the will, the list of coded paragraphs, the redline comparisons for any amended paragraphs, and all AI-generated analysis reports. This structured package is designed to maximize the efficiency of the attorney's review.

Video Script Generation (222): Once the will is finalized, the system generates a script for the testator to read. The script is displayed on the device's screen in a teleprompter format.

Pre-Recording Verification (224): Before recording, the system executes a final testator verification protocol. This includes biometric authentication and a brief, recorded cognitive assessment to establish the testator's capacity at the time of recording.

Video Recording and Editing (226): The testator reads the script, and the system records the video and audio. An automated editing module processes the raw recording to remove excessive pauses or speech disfluencies, creating a clear and concise final video. The original, unedited footage is cryptographically linked to the edited version and preserved for authentication purposes.

The video production logic is implemented as shown in FIG. 2D.

Secure Remote Execution (228, 230): The system facilitates the formal execution of the will by initiating a secure, live video conference connecting the testator, two witnesses, and a licensed remote online notary. During the recorded session, the testator, witnesses, and notary apply their respective cryptographic electronic signatures to the digital document.

Finalization and Distributed Ledger Recordation (232): Upon execution, the system assembles a final, comprehensive package containing the edited video will, the final PDF document, the full unedited video recording, the video of the execution ceremony, and all associated metadata and analysis reports. A cryptographic hash of this entire package is generated and recorded on a distributed ledger or blockchain. This action creates a permanent, tamper-evident, and time-stamped record of the will's creation and execution.

The logic for the execution phase is implemented as shown in FIG. 2E.

Completion: The process is complete. The testator and designated parties (e.g., executor) receive secure access to the final will package. This embodiment thereby provides a robust, secure, and legally compliant method for creating a video will that integrates AI-driven guidance with verifiable execution formalities.

### Example 3

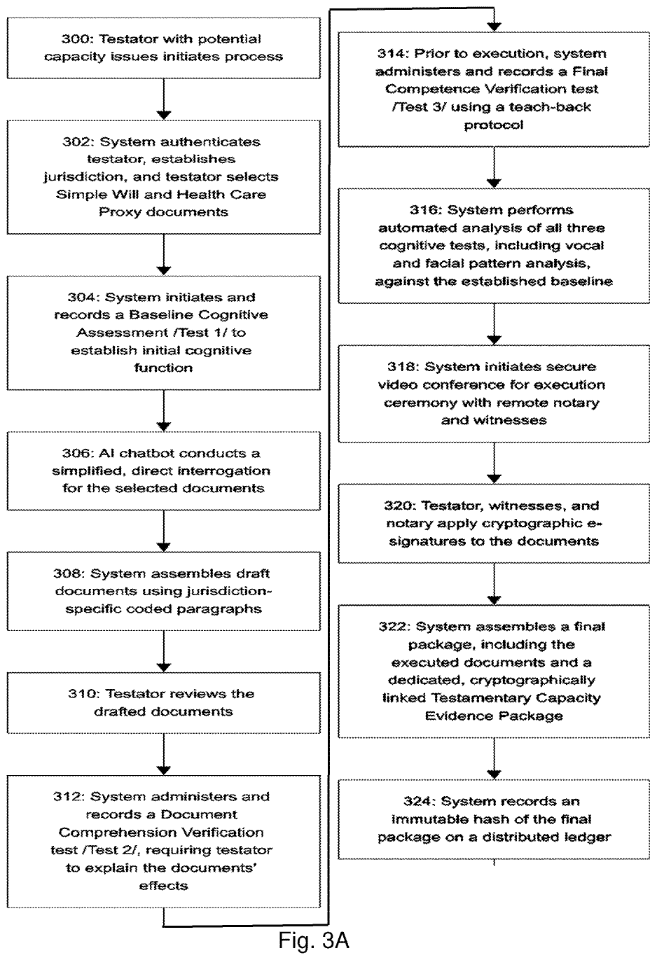

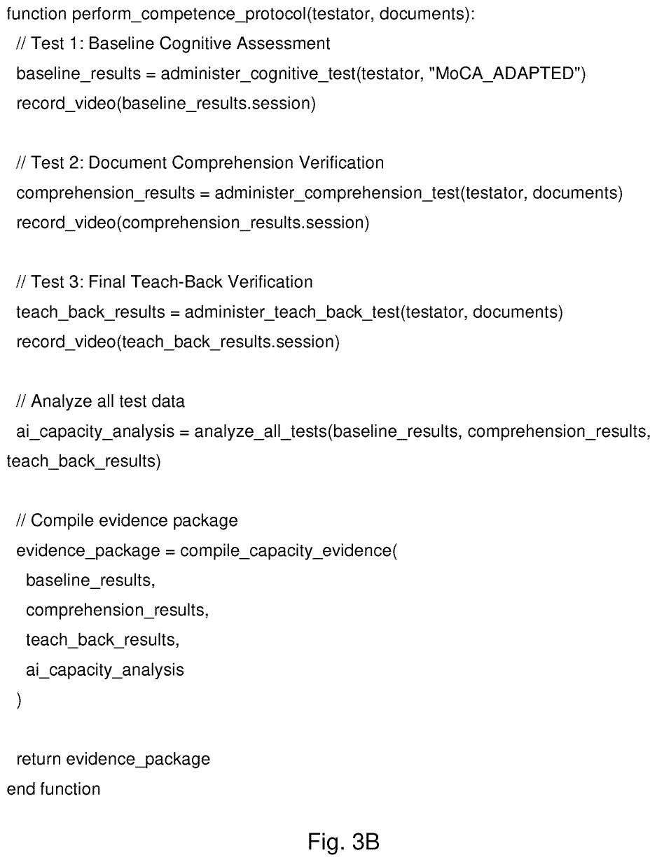

A flowchart illustrating an exemplary embodiment of the method focused on verifying testamentary capacity is provided in FIG. 3A, which provides a description of an exemplary embodiment where establishing the testator's testamentary capacity is a principal objective. A testator, an 80-year-old resident of California with a recent medical diagnosis that may impact cognitive function, utilizes the disclosed system to create a simple will and a health care proxy.

Initiation and Document Selection (300, 302): The testator initiates the process via the application. After authentication and establishing California as the governing jurisdiction, the testator selects the options to create a “Simple Last Will and Testament” and a “Health Care Proxy.” The system loads the corresponding legal modules and cognitive assessment protocols.

Baseline Cognitive Assessment (Test 1) (304): The system informs the testator that, to ensure the legal validity of the documents, a series of cognitive assessments will be administered. The first is a baseline cognitive assessment. This test, adapted from a standardized tool such as the Montreal Cognitive Assessment (MoCA), is administered by the AI chatbot. The testator is prompted to perform tasks measuring orientation, memory recall, and basic executive function. The entire interactive session is video and audio recorded.

Simplified Interrogation (306): The AI chatbot proceeds with a simplified interrogation specifically tailored for the selected documents. The questions are direct and unambiguous to minimize cognitive load. For the simple will, the testator is asked to identify a single executor and a primary beneficiary for the residuary estate. For the health care proxy, the testator is asked to identify a primary and a secondary agent.

Document Assembly and Review (308, 310): The system assembles the draft will and health care proxy using coded paragraphs specific to California law. The testator is then given an opportunity to review the documents, which are presented in a large, legible font.

Document Comprehension Verification (Test 2) (312): After the review period, the system administers a second, distinct cognitive test. This test is designed to verify the testator's comprehension of the legal documents. The AI chatbot asks open-ended questions such as, “In your own words, what authority does this document give to the person you named as your health care agent?” and “Please explain what will happen to your property according to the will you have just reviewed.” The testator's responses are recorded.

Final Competence Verification (Test 3) (314): Immediately preceding the execution ceremony, a third and final competence verification is performed. This test utilizes a “teach-back” protocol. The AI chatbot provides a concise summary of the key provisions of the will and proxy. The testator must then confirm their understanding and correctly identify the names of the executor and health care agent they appointed.

Automated Multi-Modal Analysis (316): Concurrently, an AI analysis module processes the data from all three recorded tests. This analysis includes scoring the objective answers from the cognitive assessments. Furthermore, the AI analyzes vocal biomarkers (e.g., speech rate, hesitation frequency) and facial expressions from the video recordings across all three tests to detect patterns indicative of confusion, duress, or a decline in cognitive function from the initial baseline. A comprehensive capacity score and report are generated.

The logic for this multi-stage testing is implemented as shown in FIG. 3B.

Secure Remote Execution (318, 320): Following a successful capacity verification, the system initiates the secure video conference with a remote online notary and two witnesses. The testator and all parties apply cryptographic e-signatures to the digital documents in a recorded ceremony.

Compilation of Testamentary Capacity Evidence Package (322): In addition to the executed legal documents, the system assembles a distinct “Testamentary Capacity Evidence Package.” This package comprises: (i) the full, unedited video and audio recordings of all three cognitive assessments; (ii) a transcript of the tests and the testator's responses; (iii) the objective scores from the standardized test portions; (iv) the AI-generated report on vocal and facial analysis; and (v) an immutable, time-stamped log of the entire session from initiation to completion. This evidence package is cryptographically linked to the executed will and health care proxy.

Finalization and Completion (324): A cryptographic hash of the combined final package, including the executed documents and the capacity evidence package, is recorded on a distributed ledger. This creates a highly secure and verifiable record, specifically designed to withstand legal challenges related to testamentary capacity. The process is then complete.

### Example 4

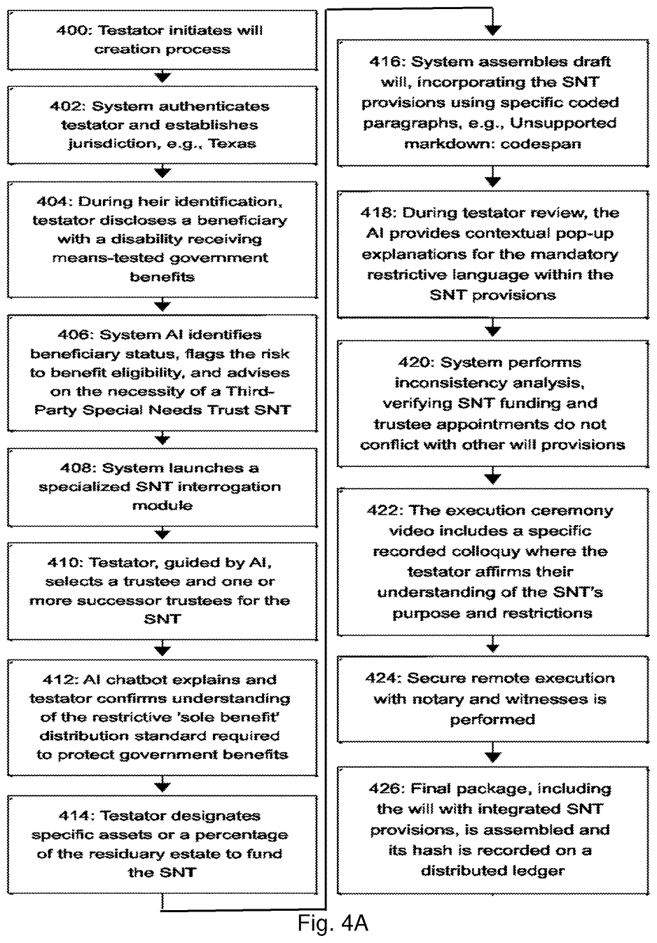

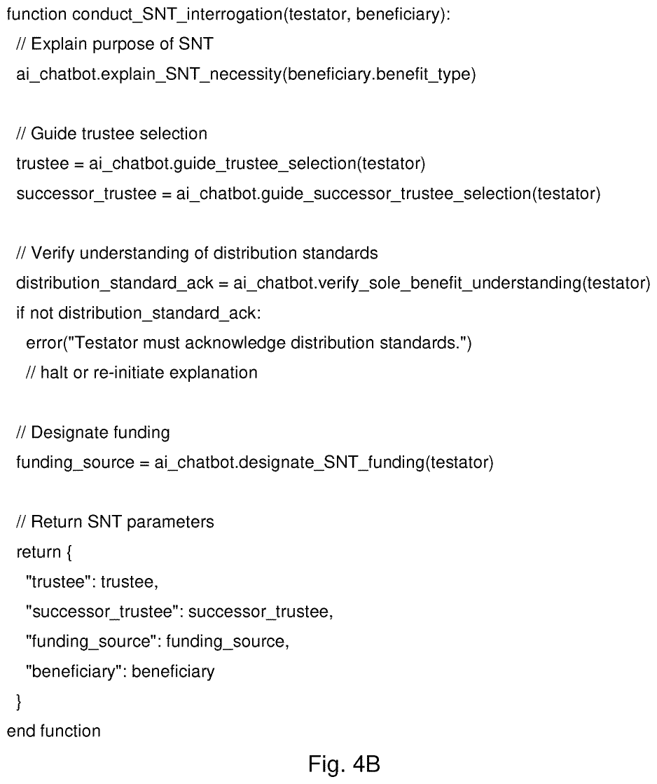

The following example, illustrated in FIG. 4A, provides a description of the creation of a testamentary Third-Party Special Needs Trust (SNT) is required. A testator, a resident of Texas, wishes to provide for an adult child who has a disability and receives means-tested government benefits, such as Supplemental Security Income (SSI) and Medicaid.

Initiation and Jurisdiction (400, 402): The testator initiates the will creation process. The system authenticates the testator and establishes Texas as the governing jurisdiction.

Identification of Beneficiary with Special Needs (404): During the heir identification module, the testator lists their adult child as a beneficiary. In response to a system prompt, the testator indicates that this child has a permanent disability and is a recipient of government benefits.

AI-Driven SNT Advisory (406): The system's AI immediately flags this disclosure. It accesses its jurisdiction-specific knowledge base for Texas and determines that an outright inheritance would be counted as a resource, thereby disqualifying the child from their essential, means-tested government benefits. The AI chatbot communicates this risk to the testator in clear, non-technical language and advises that the proper legal instrument to avoid this outcome is a Third-Party Special Needs Trust established within the will.

Specialized SNT Interrogation (408, 410, 412): The system launches a specialized SNT interrogation module. This module guides the testator through the specific requirements for creating a compliant SNT under Texas and federal law. Key steps include:

Trustee Selection: The testator is prompted to name a trustee to manage the SNT funds, and at least one successor trustee. The AI explains the fiduciary duties of a trustee.

Distribution Standard Confirmation: The AI explains the restrictive distribution standard, emphasizing that trust assets can only be used for the “sole benefit” of the child and cannot be used for items or services that would be provided by government benefits (e.g., food, shelter). The testator must affirmatively confirm their understanding of these restrictions in a recorded colloquy.

SNT Funding (414): The testator is prompted to designate the assets that will fund the SNT. This may be a specific asset, a pecuniary amount, or a percentage of the residuary estate.

The logic for this specialized interrogation is implemented as shown in FIG. 4B.

Document Assembly with Contextual Explanations(416, 418): The system assembles the draft will, incorporating the SNT provisions using specific coded paragraphs (e.g., TX-SNT-PROV-001). During the testator's review, when the testator views the highly restrictive legal language required for the SNT to be compliant, the system provides pop-up windows with simplified explanations for why such language is mandatory to protect the beneficiary's government benefits.

Inconsistency Analysis (420): The system's inconsistency analysis module performs a check to ensure the SNT provisions are harmonized with the rest of the will. It verifies that assets designated to fund the SNT are not bequeathed elsewhere and that the named trustee is not assigned conflicting duties.

Execution with Specific Affirmation (422, 424): Before the final e-signature, the execution ceremony includes a specific, recorded colloquy. The AI prompts the testator with questions like, “Do you understand that the funds in this trust are controlled by the trustee and cannot be given directly to your child?” and “Do you understand that this trust is designed to supplement, not replace, government benefits?” The testator's affirmative answers are captured as part of the execution video. The secure remote execution with the notary and witnesses then proceeds.

Finalization (426): The final package, containing the will with the fully integrated SNT and the execution video with the specific SNT colloquy, is assembled. A cryptographic hash of this package is recorded on a distributed ledger, and the process is complete.

### Example 5

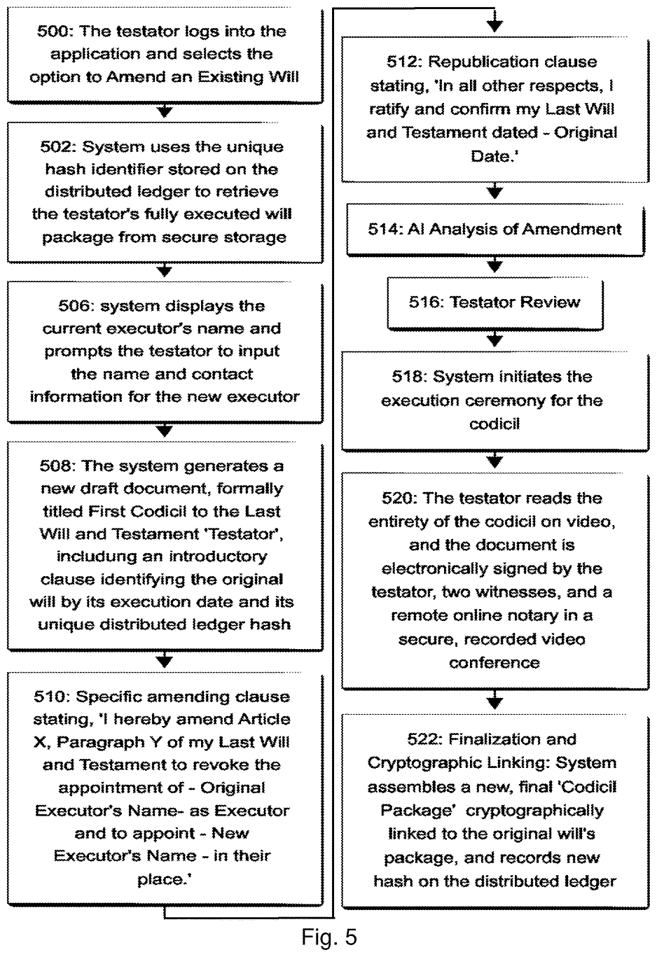

The following example, illustrated in FIG. 5, provides a description of an embodiment for creating a codicil to amend an existing will. A testator, a resident of Florida, created a will using the system two years prior. Due to the passing of the originally named executor, the testator amends the will to appoint a new one.

Initiation and Will Retrieval (500, 502): The testator logs into the application and selects the option to “Amend an Existing Will.” After authentication, the system uses the unique hash identifier stored on the distributed ledger to retrieve the testator's fully executed will package from secure storage.

Amendment Identification (504, 506): The system displays the testator's existing will. The testator navigates to the article concerning the appointment of fiduciaries and selects the coded paragraph FL-EXEC-001. The system displays the current executor's name and prompts the testator to input the name and contact information for the new executor.

Codicil Generation and Republication (508, 510, 512): The system generates a new draft document, formally titled “First Codicil to the Last Will and Testament of [Testator's Name].” This document includes:
An introductory clause identifying the original will by its execution date and its unique distributed ledger hash.
A specific amending clause stating, “I hereby amend Article [X], Paragraph [Y] of my Last Will and Testament to revoke the appointment of [Original Executor's Name] as Executor and to appoint [New Executor's Name] in their place.” A redline comparison of the change is included for clarity.
A republication clause stating, “In all other respects, I ratify and confirm my Last Will and Testament dated [Original Date].”

AI Analysis of Amendment (514): The AI analysis module processes the change. It verifies that the newly named executor meets the legal requirements to serve in Florida (e.g., age, residency status). If the new executor resides out-of-state, the AI flags potential complications, such as the need to post a bond, and presents this information to the testator.

Testator Review (516): The testator reviews the draft codicil and the AI analysis report. After confirming the details, the testator approves the document for execution.

Codicil Execution (518, 520): The system initiates the execution ceremony for the codicil. This process mirrors the formality of the original will execution. The testator reads the entirety of the codicil on video, and the document is electronically signed by the testator, two witnesses, and a remote online notary in a secure, recorded video conference.

Finalization and Cryptographic Linking (522, 524): The system assembles a new, final “Codicil Package.” This package is cryptographically linked to the original will's package. A new hash, corresponding only to the Codicil Package, is recorded on the distributed ledger. This creates a clear, sequential, and auditable chain of testamentary documents, ensuring that any future review can easily identify both the original will and its legally executed amendments. The process is then complete.

### Example 6

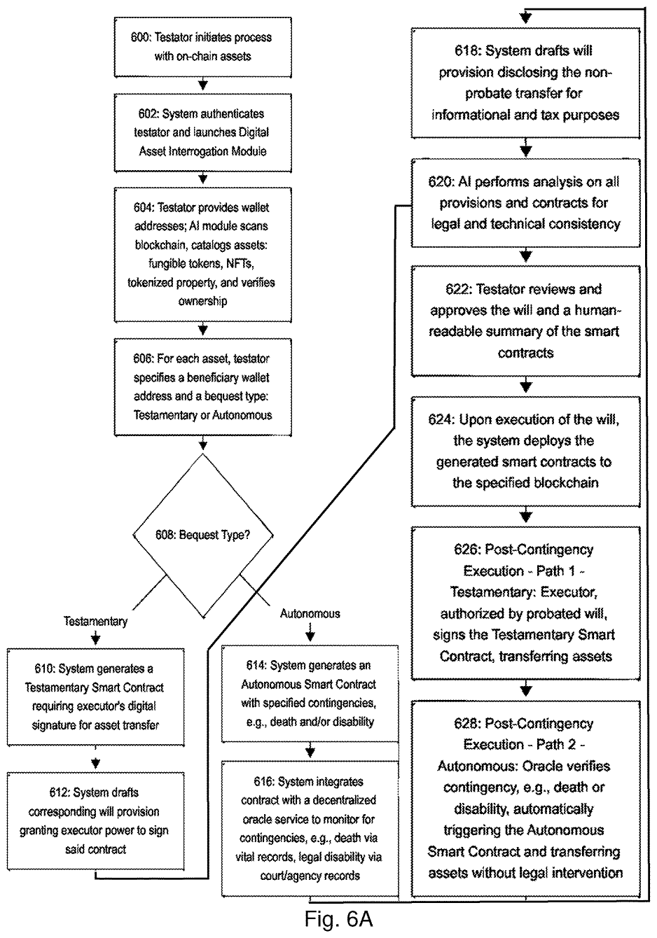

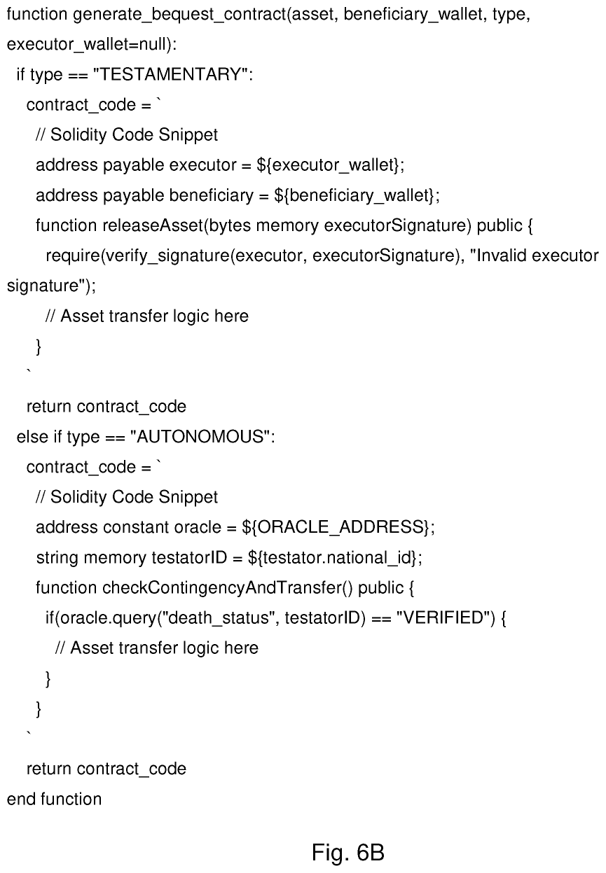

The following example, illustrated in FIG. 6A, provides a description of an embodiment where the testator's estate includes significant assets recorded on a public blockchain. A testator, a resident of a jurisdiction recognizing electronic wills, wishes to bequeath these digital assets using a combination of testamentary and non-testamentary instruments generated by the system.

Initiation and Digital Asset Identification (600, 602): The testator initiates the will creation process. After authentication, a specialized Digital Asset Interrogation Module is launched. The testator provides their public wallet addresses. The AI module interfaces with the blockchain's public ledger to scan these addresses, automatically identifying and cataloging all associated digital assets. This includes fungible tokens (e.g., ERC-20), non-fungible tokens (NFTs, e.g., ERC-721), tokenized real estate deeds, and smart contracts representing financial instruments such as loans. The system verifies the testator's control of the wallet, typically via a cryptographic signature challenge.

Bequest Specification and Type Selection (604, 606, 608): For each identified digital asset, the AI chatbot prompts the testator to name a beneficiary by providing the beneficiary's public wallet address. Crucially, the testator must then select one of two bequest types for each asset:
Testamentary Transfer: The asset transfer is subject to the administration of the will and probate law.
Autonomous Transfer: The asset transfer is designed to occur automatically upon a specified contingency, bypassing the probate process.

Testamentary Smart Contract Generation (610, 612): The testator chooses to bequeath a portfolio of fungible tokens to their eldest child via a Testamentary Transfer. The system's Smart Contract Generation Module writes and compiles a smart contract. The logic of this contract dictates that the tokens held at a specific address can only be transferred to the beneficiary's wallet address upon receiving a valid digital signature from a designated executor's wallet address. Concurrently, the will-drafting module generates a corresponding coded paragraph (e.g., WY-DABE-001) in the will, which: (i) identifies the fungible tokens and the testator's wallet; (ii) names the beneficiary and their wallet; and (iii) explicitly grants the named executor the power and authority to execute the transfer by signing the associated smart contract with the private key corresponding to the executor's public key, which is also referenced in the will.

Autonomous Smart Contract Generation with Oracle Integration (614, 616, 618): The testator chooses to bequeath a specific NFT, representing a piece of digital art, to a friend via an Autonomous Transfer. The system generates a different type of smart contract. The contingency for this contract is the testator's death. To verify this off-chain event, the smart contract is coded to interface with a decentralized, reliable oracle service. This oracle is a trusted entity that monitors official, digitized government vital records. Upon the issuance of a legally valid death certificate for the testator, the oracle fetches this data, verifies its authenticity, and reports the event to the blockchain.

The logic of the autonomous smart contract is as follows:
IF oracle_service. getDeathCertificateStatus(Testator_National_ID)==“VERIFIED_DECEASED”
THEN transfer(NFT_contract_address, NFT_ID) FROM testator_wallet TO beneficiary_wallet.

Simultaneously, the will-drafting AI generates a disclosure provision. This provision states, for the record, that the specified NFT is intended to pass outside of the probate estate pursuant to a self-executing smart contract and that this bequest is listed for estate tax and accounting purposes only. The AI chatbot explicitly explains to the testator that this transfer is irrevocable upon deployment and will occur without court or executor intervention.

The logic for smart contract generation is implemented as shown in FIG. 6B.

Analysis and Review (620, 622): The system's AI performs a final analysis, ensuring that assets designated for autonomous transfer are not also included in testamentary bequests, and vice-versa. The testator reviews the final will and a human-readable summary of the logic and triggers for each generated smart contract.

Execution and Deployment (624): During the formal video execution of the will, the testator re-affirms their understanding of the two different types of digital asset bequests. Upon the cryptographic signing of the will by the testator, witnesses, and notary, the system automatically deploys the generated smart contracts to the relevant blockchain, rendering them active and awaiting their trigger conditions.

Post-Mortem Execution (626, 628): Upon the testator's death, two distinct pathways are followed. For the fungible tokens (Testamentary), the will is probated. The legally appointed executor, using their private key, signs a transaction calling the releaseAsset function on the testamentary smart contract, and the tokens are transferred to the beneficiary. For the NFT (Autonomous), the oracle detects the death certificate, reports it on-chain, and the smart contract's checkContingencyAndTransfer function is automatically executed, transferring the NFT to the friend's wallet, entirely outside the purview of the probate court.

### Example 7

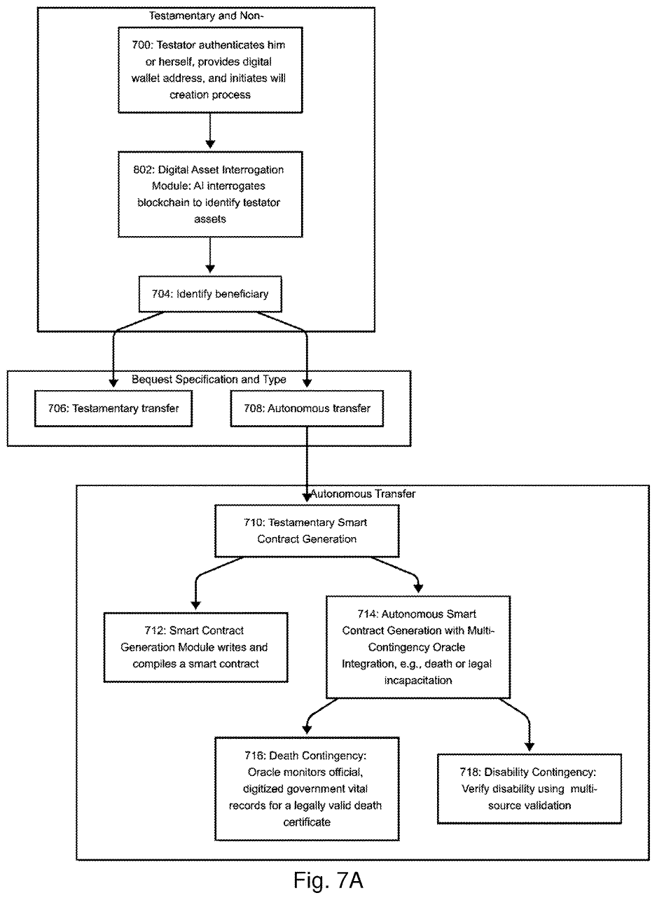

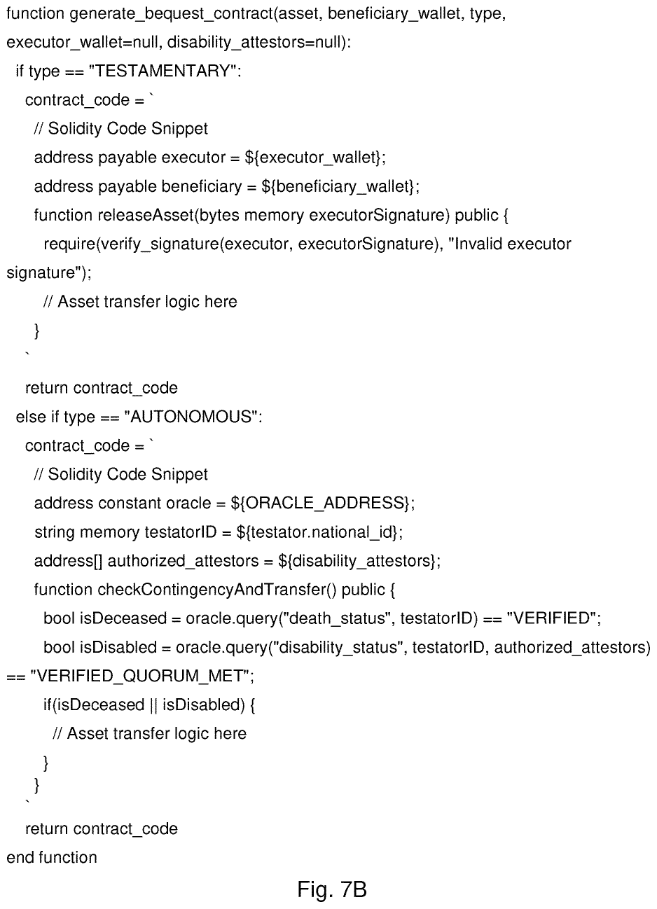

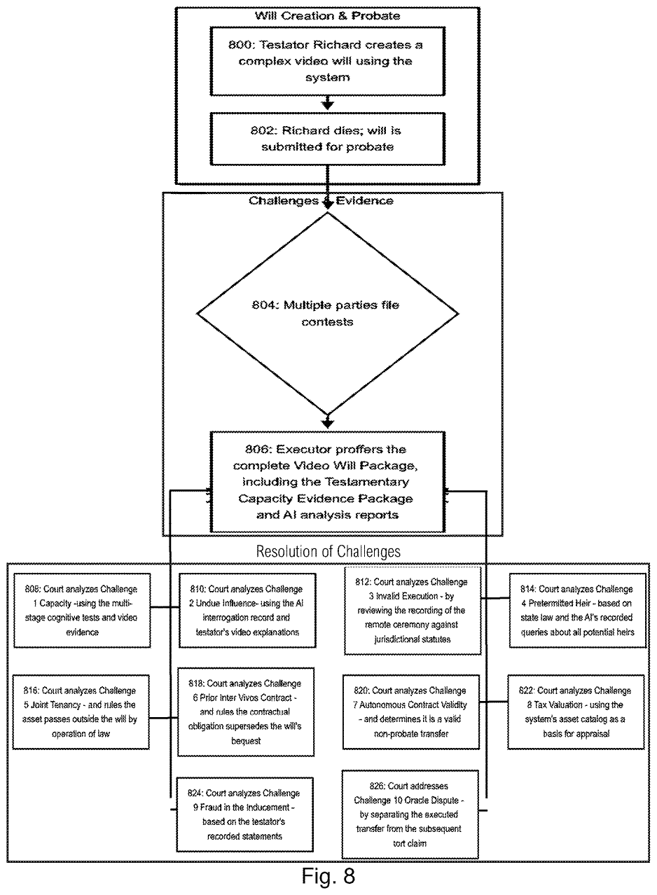

The following example, illustrated in FIG. 7A, provides a description of an embodiment where the testator's estate includes significant assets recorded on a public blockchain. A testator, a resident of a jurisdiction recognizing electronic wills, wishes to bequeath these digital assets using a combination of testamentary and non-testamentary instruments generated by the system.

Initiation and Digital Asset Identification (700, 702): The testator initiates the will creation process. After authentication, a specialized Digital Asset Interrogation Module is launched. The testator provides their public wallet addresses. The AI module interfaces with the blockchain's public ledger to scan these addresses, automatically identifying and cataloging all associated digital assets. This includes fungible tokens (e.g., ERC-20), non-fungible tokens (NFTs, e.g., ERC-721), tokenized real estate deeds, and smart contracts representing financial instruments such as loans. The system verifies the testator's control of the wallet, typically via a cryptographic signature challenge.

Bequest Specification and Type Selection (704, 706, 708): For each identified digital asset, the AI chatbot prompts the testator to name a beneficiary by providing the beneficiary's public wallet address. Crucially, the testator must then select one of two bequest types for each asset:

Testamentary Transfer: The asset transfer is subject to the administration of the will and probate law.

Autonomous Transfer: The asset transfer is designed to occur automatically upon a specified contingency, bypassing the probate process.

Testamentary Smart Contract Generation (710, 712): The testator chooses to bequeath a portfolio of fungible tokens to their eldest child via a Testamentary Transfer. The system's Smart Contract Generation Module writes and compiles a smart contract. The logic of this contract dictates that the tokens held at a specific address can only be transferred to the beneficiary's wallet address upon receiving a valid digital signature from a designated executor's wallet address. Concurrently, the will-drafting module generates a corresponding coded paragraph (e.g., WY-DABE-001) in the will, which: (i) identifies the fungible tokens and the testator's wallet; (ii) names the beneficiary and their wallet; and (iii) explicitly grants the named executor the power and authority to execute the transfer by signing the associated smart contract with the private key corresponding to the executor's public key, which is also referenced in the will.

Autonomous Smart Contract Generation with Multi-Contingency Oracle Integration (714, 716, 718): The testator chooses to bequeath a specific NFT, representing a piece of digital art, to a friend via an Autonomous Transfer, to be triggered by either the testator's death or legal incapacitation (disability).

The system generates a more complex smart contract to handle these dual contingencies. The contract is coded to interface with a decentralized, reliable oracle service capable of verifying multiple off-chain events.

Death Contingency: As previously described, the oracle monitors official, digitized government vital records for a legally valid death certificate.

Disability Contingency: Verifying legal disability is more complex than verifying death and requires a higher degree of trust and multi-source validation. The system facilitates this by:
Pre-authorization during Will Creation: The AI chatbot guides the testator to pre-authorize specific, trusted entities to make a determination of disability. For example, the testator might designate two named physicians and a specific court of competent jurisdiction. The system generates the necessary legal authorizations (e.g., HIPAA releases) for the testator to electronically sign, which are stored securely and linked to the oracle's operational parameters.
Oracle Attestation Mechanism: The oracle is configured to require a quorum of attestations from these pre-authorized sources. For instance, the smart contract logic may require a valid, cryptographically signed message from the wallets of both designated physicians, or a single signed message from the designated court, before the disability contingency is met. The oracle's role is to verify the authenticity of these signatures against the pre-authorized wallet addresses and report the confirmed “DISABLED” state to the smart contract.

The logic for this advanced autonomous smart contract is as follows:
IF (oracle_service.getDeathCertificateStatus(Testator_ID)==“VERIFIED_DECEASED”) OR (oracle_service.getDisabilityStatus(Testator_ID)==“VERIFIED_DISABLED_QUORUM_MET”)
THEN transfer(NFT_contract_address, NFT_ID) FROM testator_wallet TO beneficiary_wallet.

Simultaneously, the will-drafting AI generates a disclosure provision stating that the NFT is intended to pass outside of the probate estate and explaining both the death and disability triggers. The AI chatbot explicitly explains to the testator that this transfer is irrevocable upon deployment and will occur without court or executor intervention upon the satisfaction of either contingency.

The logic for smart contract generation is implemented as shown in FIG. 7B.

Analysis and Review (720, 722): The system's AI performs a final analysis, ensuring that assets designated for autonomous transfer are not also included in testamentary bequests, and vice-versa. The testator reviews the final will and a human-readable summary of the logic and triggers for each generated smart contract.

Execution and Deployment (724): During the formal video execution of the will, the testator re-affirms their understanding of the two different types of digital asset bequests and the specific triggers for the autonomous transfer. Upon the cryptographic signing of the will, the system automatically deploys the generated smart contracts to the relevant blockchain.

Post-Mortem/Post-Disability Execution (726, 728): Upon the testator's death or legal incapacitation, two distinct pathways are followed. For the fungible tokens (Testamentary), the will is probated, and the executor signs the transaction. For the NFT (Autonomous), the oracle detects either the death certificate or the required attestations of disability, reports the valid contingency on-chain, and the smart contract automatically transfers the NFT to the friend's wallet, entirely outside the purview of the probate court.

### Example 8

The following example, illustrated in FIG. 8, provides a scenario to illustrate how the features of the disclosed system would be utilized in the context of a will contest.

Factual Scenario: Richard, a 78-year-old tech mogul residing in New York, used the video will system to create his will six months before his death. Richard was known for his eccentric personality and had been diagnosed with a mild neurocognitive disorder, though his physicians stated he retained capacity. His estate is vast and complex, including traditional assets and a large portfolio of digital assets.

Richard's will, created via the system, contains the following key provisions:
His daughter, Brenda, is appointed executrix.
His entire collection of fungible cryptocurrency (Bitcoin and Ether) is to be transferred to Brenda via a Testamentary Smart Contract.
A valuable NFT art collection is to be transferred to his alma mater, a qualified charity, via an Autonomous Smart Contract triggered by his death.
His son, Charles, is explicitly disinherited with a statement recorded on video explaining that Charles has already received substantial lifetime gifts.
A vacation home, held in joint tenancy with Brenda, is bequeathed to his loyal assistant, Diana.
A valuable physical painting is bequeathed to a museum, despite a clause in his divorce decree with his ex-wife, Evelyn, stating the painting was to be hers.
The residuary of his estate is left to Brenda.
Will Creation and Probate (800, 802): Richard creates this will using the system, completing the multi-stage cognitive assessments. Upon his death, Brenda submits the will package for probate in New York.

Filing of Contests: Several parties file contests (804, 806):
Charles (Disinherited Son): Challenges on the grounds of (1) lack of testamentary capacity, (2) undue influence by Brenda, and (9) fraud in the inducement.
Evelyn (Ex-Wife): Challenges the bequest of the painting (6).
Fiona (Previously Unknown Daughter): Files a claim as a pretermitted heir (4), proving her paternity with a DNA test.
State Tax Authority: Challenges the valuation of the NFT collection for estate tax purposes (8).
Diana (Assistant): Sues to receive the vacation home (5).
Brenda (Executrix): Seeks to validate the will and also claims the vacation home (5).
A creditor of the estate: Challenges the validity of the Autonomous Smart Contract transfer to the university, arguing it improperly removes assets from the probate estate (7).
The Executrix proffers the complete, cryptographically secured Video Will Package from the system as evidence. The court proceeds to analyze each challenge.

Resolution of Challenges:
Challenge 1: Lack of Testamentary Capacity (Charles): Charles argues Richard's diagnosis made him incapable of understanding his will. Resolution: The court relies heavily on the Testamentary Capacity Evidence Package. It reviews (i) the baseline cognitive assessment (Test 1), showing Richard's cognitive state before drafting; (ii) the Document Comprehension test (Test 2), where Richard explained the will's effects in his own words; and (iii) the Final Competence Verification (Test 3). The AI's multi-modal analysis report, showing consistent vocal patterns and no signs of confusion across the tests, provides objective support. The video evidence of Richard lucidly explaining his decisions is deemed powerful evidence of capacity. The challenge is likely to fail.
Challenge 2: Undue Influence (Charles): Charles claims Brenda isolated Richard and coerced him. Resolution: The court reviews the unedited video of the AI chatbot's interrogation. The recording shows Richard alone, interacting directly with the neutral AI, free from the presence of others. The video also contains Richard's unsolicited, detailed explanation for favoring Brenda, which appears genuine and unrehearsed. This direct evidence makes the undue influence claim difficult to sustain.
Challenge 3: Invalid Will Execution (Hypothetical): Though not filed here, if a party challenged the remote ceremony, the court would review the complete, unedited recording of the execution. This recording would show the notary verifying identities and locations as per New York's remote notarization statute, and the witnesses affirming they are witnessing the signing. The system's compliance log, showing adherence to jurisdictional requirements, would further validate the execution.
Challenge 4: Pretermitted Heir (Fiona): Fiona, an unknown illegitimate child, claims a share under intestate laws. Resolution: The court first establishes her status as a child. It then reviews the AI interrogation log. The AI is programmed to ask, “Are there any other children, including any you have not had contact with, that you may have?” Richard's recorded “No” answer, while factually incorrect, is evidence of his lack of knowledge, not an intent to disinherit her specifically. Under New York law, a child born after a will is executed may have rights, but Fiona was born before. As she was not contemplated, and the will does not explicitly disinherit all unknown heirs, she may have a successful claim to an intestate share. The system's record provides clear evidence of the testator's state of knowledge at the time.
Challenge 5: Joint Tenancy (Brenda vs. Diana): The will gives the vacation home to Diana, but the deed shows it was held by Richard and Brenda as joint tenants with right of survivorship (JTWROS). Resolution: This is a matter of property law, not will interpretation. Property held in JTWROS passes automatically to the surviving joint tenant outside of the will. The bequest to Diana fails (adeems). The system's AI asset interrogation module should ideally flag this conflict during will creation, but the legal outcome is that Brenda receives the house by operation of law.
Challenge 6: Prior Inter Vivos Contract (Evelyn): Evelyn produces the divorce decree, a binding contract, giving her the painting. Resolution: A valid contract to convey property supersedes a later testamentary gift of the same property. Richard's bequest to the museum is an attempted breach of contract. The court will likely impose a constructive trust on the painting for Evelyn's benefit, ordering the estate to turn it over to her.
Challenge 7: Autonomous Contract Validity (Creditor): The creditor argues the direct-to-charity NFT transfer is a fraudulent conveyance to avoid estate debts. Resolution: The court faces a novel issue. However, the system's design helps. The will's disclosure provision proves there was no intent to hide the asset. The transfer is analogous to other non-probate transfers like a payable-on-death account. So long as the transfer does not render the estate insolvent, it is likely to be upheld as a valid non-probate transfer, though the value of the gift may still be included in the taxable estate.
Challenge 8: Tax Valuation (Tax Authority): The state challenges the estate's valuation of the NFT collection. Resolution: While the video will system cannot perform appraisals, its Digital Asset Interrogation Module provides a clear, time-stamped catalog of the specific NFTs (by contract address and token ID) held at the time of will creation. This provides a definitive list of assets to be valued, preventing disputes over what was in the collection. The resolution will depend on expert appraisals, but the system provides the foundational evidence.
Challenge 9: Fraud in the Inducement (Charles): Charles claims Brenda falsely told Richard he had a gambling problem. Resolution: This claim is extremely difficult to prove. The primary evidence would be the video will itself. The court would scrutinize Richard's recorded statement for disinheriting Charles. If Richard says, “I am disinheriting Charles because he has received substantial lifetime gifts for his education and business,” without mentioning gambling, it directly contradicts and defeats the fraud claim.
Challenge 10: Oracle Dispute (Hypothetical): Had an asset been transferred via a disability contingency, and a party later proved one of the attesting physicians committed fraud, the situation would be complex. The on-chain transfer via the smart contract would be immutable and final. The court could not reverse the blockchain transaction. The aggrieved party's remedy would not be to void the transfer but to file a separate civil suit against the fraudulent physician for damages, demonstrating a key paradigm shift where legal remedies may target off-chain actions rather than on-chain results.

### Example 9

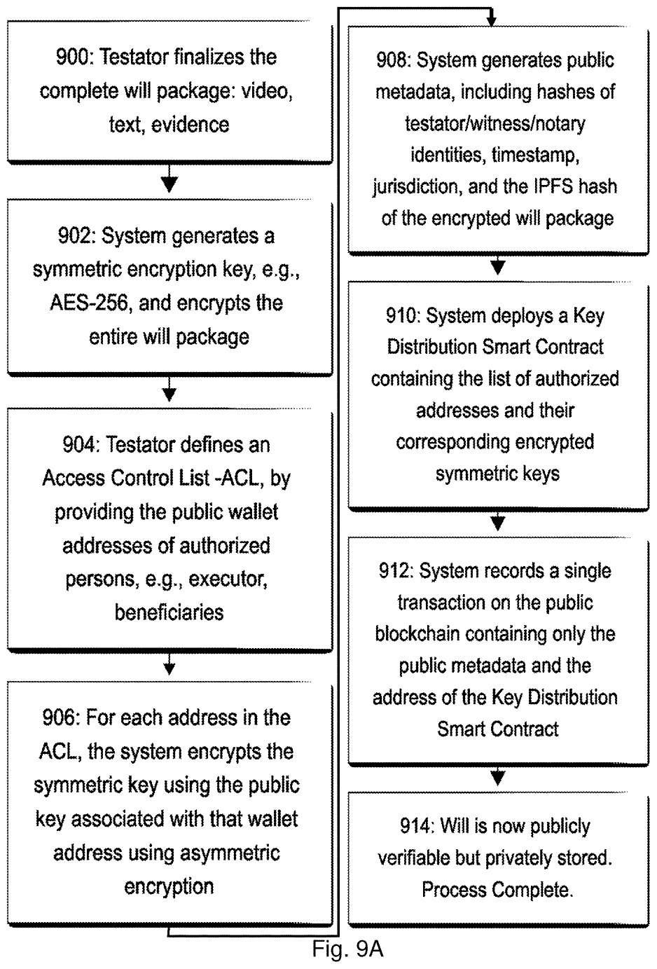

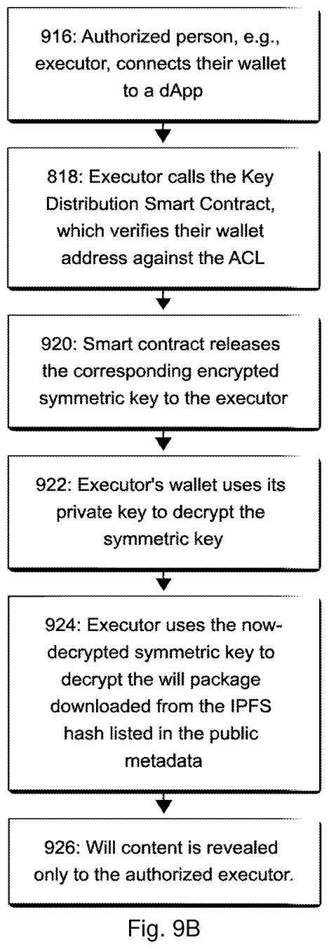

The following example, illustrated in FIGS. 9A and 9B, provide descriptions of an embodiment for storing a will on a public, immutable ledger while ensuring the confidentiality of its contents. This method addresses the dichotomy between the need for public verifiability and the testator's right to privacy.

Will Package Encryption (900, 902): A testator, having completed the will creation and execution process as described in prior examples, has a final, comprehensive will package. This package, containing the video recording, the text document, and all associated evidence files, is treated as a single data object. The system generates a strong, single-use symmetric encryption key (e.g., an AES-256 key) and uses it to encrypt the entire will package. The result is an encrypted data blob that is unintelligible without the corresponding decryption key.

Access Control and Asymmetric Encryption (904, 906): The testator defines an Access Control List (ACL) by providing the public cryptocurrency wallet addresses of all persons who should have access to the will's contents after the testator's death (e.g., the executor, successor executor, and key beneficiaries). The system then performs an asymmetric encryption process: for each authorized wallet address on the ACL, the system encrypts a copy of the single symmetric AES key using the public key associated with that specific wallet. This results in multiple encrypted versions of the same symmetric key, where each version can only be decrypted by the private key of its intended recipient.

Public Recordation and Key Distribution (908, 910, 912): The system prepares a transaction to be recorded on a public blockchain (e.g., Ethereum). This single transaction contains two components:

Public Metadata: A collection of data designed to be publicly viewable. This metadata does not include any personally identifiable information. Instead, it contains cryptographic hashes of the identities of the testator, witnesses, and notary; a timestamp of the execution; a code representing the jurisdiction; and, crucially, a hash-based address pointing to the location of the encrypted will package on a decentralized file storage system (e.g., the InterPlanetary File System, IPFS).

Smart Contract Address: The address of a newly deployed “Key Distribution Smart Contract.” This smart contract holds the list of authorized wallet addresses and their corresponding asymmetrically encrypted symmetric keys.

The transaction is recorded on the blockchain. The result is that the existence of the will, the fact of its proper execution, and the location of its encrypted container are all publicly and immutably verified, but the contents remain completely secret.

Post-Mortem Decryption Process (916-926): After the testator's death, the named executor (or another authorized person) can access the will's contents. The process is as follows:

The executor locates the public transaction on the blockchain, which could be found via a hash provided by the testator or by searching for transactions associated with the testator's public key.

From the public metadata in that transaction, the executor obtains the IPFS address and downloads the encrypted will package.

Using a dApp (decentralized application), the executor connects their wallet (whose address is on the ACL) and calls a function on the Key Distribution Smart Contract.

The smart contract verifies that the wallet address making the call is on the ACL and releases the specific version of the encrypted symmetric key that was encrypted for that address.

The executor's wallet software automatically uses their private key to decrypt this data, revealing the original AES-256 symmetric key.

The executor then uses this AES key to decrypt the will package, revealing the video will and all associated documents.

This method successfully separates the public proof of the will from its private contents, providing a secure, transparent, and confidential method of testamentary record-keeping.

### Example 10

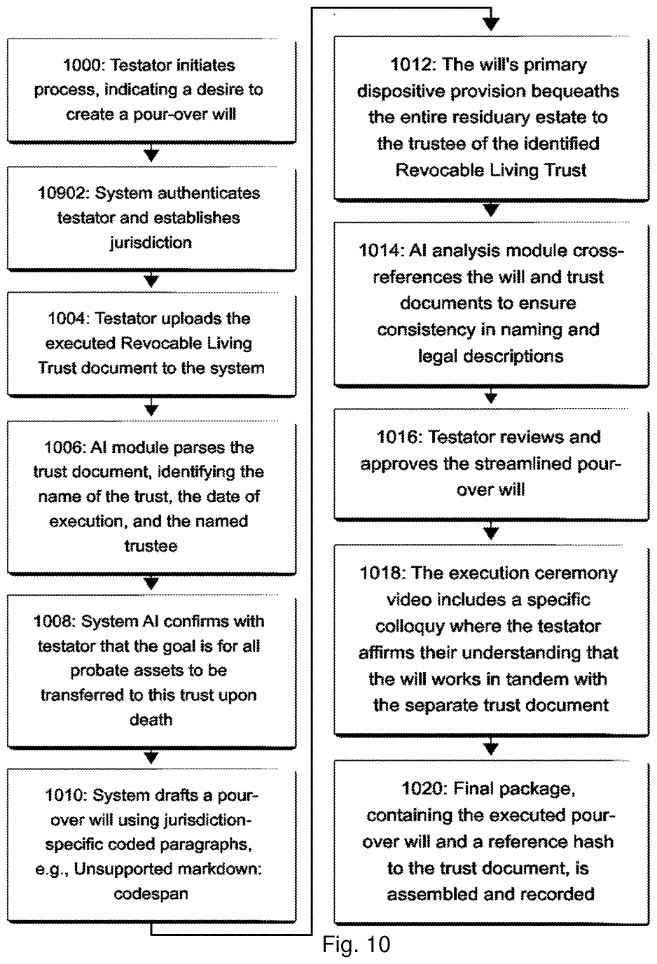

FIG. 10 shows a flowchart illustrating an embodiment for creating a pour-over will that works in conjunction with a pre-existing trust. This example describes the creation of a “pour-over” will, a specific type of will used to transfer any assets from the testator's probate estate into a pre-existing Revocable Living Trust.

Initiation and Trust Identification (1000-1004): A testator in California initiates the process, selecting the “Pour-Over Will” option. The system prompts the testator to upload a digital copy of their fully executed Revocable Living Trust. The system's AI module parses the uploaded document to extract key information: the official name of the trust, its date of creation, and the identity of the named trustee(s).

Will Drafting and Integration (1006-1012): The AI chatbot confirms the testator's intent. The system then drafts a pour-over will. The central, operative clause of this will is a single dispositive provision that bequeaths the entire residuary of the testator's estate to the current trustee of the “Testator's Name Revocable Living Trust dated [Date].” This ensures any assets inadvertently left out of the trust during the testator's lifetime are incorporated into the trust structure upon their death and distributed according to its terms.

Analysis, Execution, and Finalization (1014-1020): The AI analysis module verifies that the trust details in the pour-over will perfectly match the uploaded trust document. The testator then reviews the document and proceeds to the execution ceremony. During the video execution, the testator is asked to affirm their understanding that the will's only function is to fund the trust. The final, executed pour-over will is then packaged and its hash recorded on the distributed ledger, often with a non-binding reference hash of the separate trust document for complete record-keeping.

### Example 11

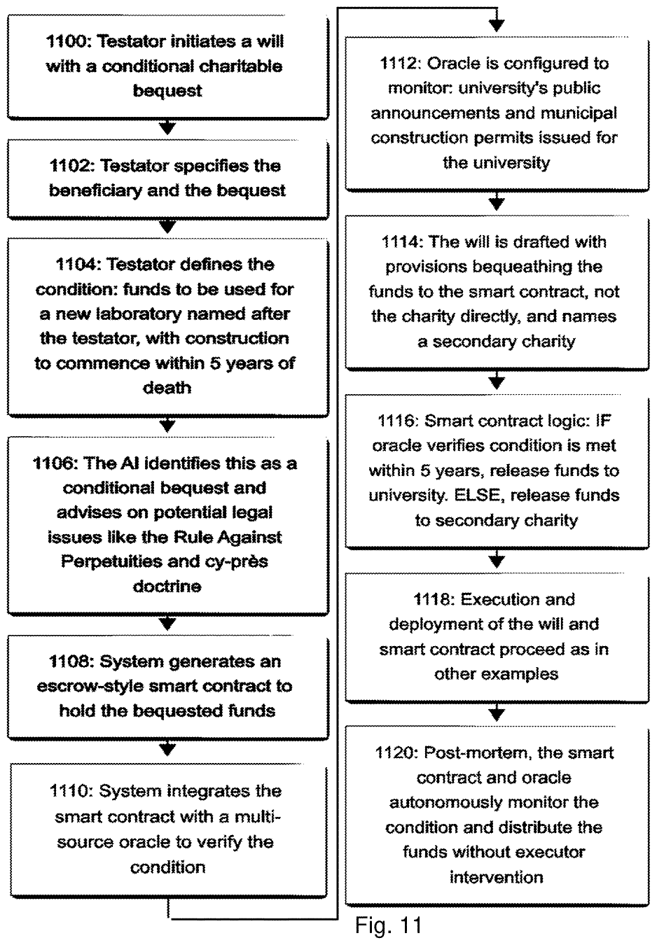

This example, illustrated in FIG. 11, details the creation of a complex charitable gift with a condition subsequent, managed autonomously by a smart contract.

Defining the Conditional Bequest (1100-1104): A testator wishes to leave a substantial sum to a university on the condition that it is used to build a new laboratory named in their honor, with construction beginning within five years of the testator's death.

AI Advisory and Smart Contract Configuration (1106-1112): The system's AI recognizes the legal complexity of a conditional gift. It advises the testator on potential issues and drafts a solution using a smart contract. An escrow-style smart contract is created to hold the funds. This contract is linked to a decentralized oracle service tasked with monitoring both the university's official public statements and the local municipality's public database for construction permits.

Document and Contract Integration (1114-1120): The will is drafted to bequeath the funds not to the university directly, but to the address of the smart contract. The will also names a secondary charity. The smart contract's logic is simple: if the oracle provides cryptographic proof that the condition (commencement of construction) is met within the five-year timeframe, the funds are released to the university's wallet. If the five-year period lapses without the condition being met, the funds are automatically transferred to the secondary charity. This entire process occurs automatically and transparently on the blockchain after the testator's death.

### Example 12

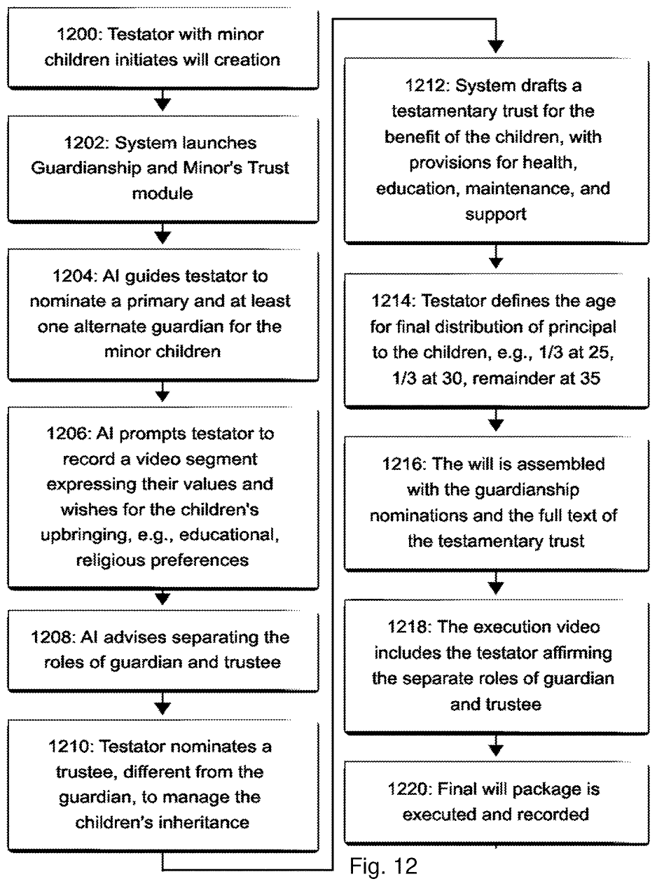

This example, illustrated in FIG. 12, describes the process for a testator with minor children, focusing on the nomination of a guardian and the creation of a trust to manage their inheritance.

Guardian Nomination and Personal Wishes (1200-1206): A testator initiates the will process, indicating they have minor children. The system launches a specialized module. The AI guides the testator to nominate a guardian and at least one alternate. Crucially, the system then prompts the testator to record a separate, heartfelt video message to the nominated guardian, explaining their hopes, values, and specific wishes for their children's care and upbringing. While not legally binding, this video provides invaluable guidance to the guardian and the court.

Creation of Minor's Trust (1208-1214): The AI explains the benefit of separating the roles of personal guardian and financial trustee. The testator nominates a separate individual or institution as trustee. The system then drafts a comprehensive testamentary trust, funded by the residuary estate, for the benefit of the children. The testator is guided to define the terms, such as using the funds for health and education, and setting staggered ages (e.g., 25, 30, and 35) for the children to receive the principal, protecting them from youthful financial mismanagement.

Finalization (1216-1220): The final will document incorporates both the legal nomination of the guardian and the full text of the testamentary trust. The execution ceremony includes the testator affirming their choices for both roles, and the final package provides a clear, legally sound plan for the care and financial security of their children.

### Example 13

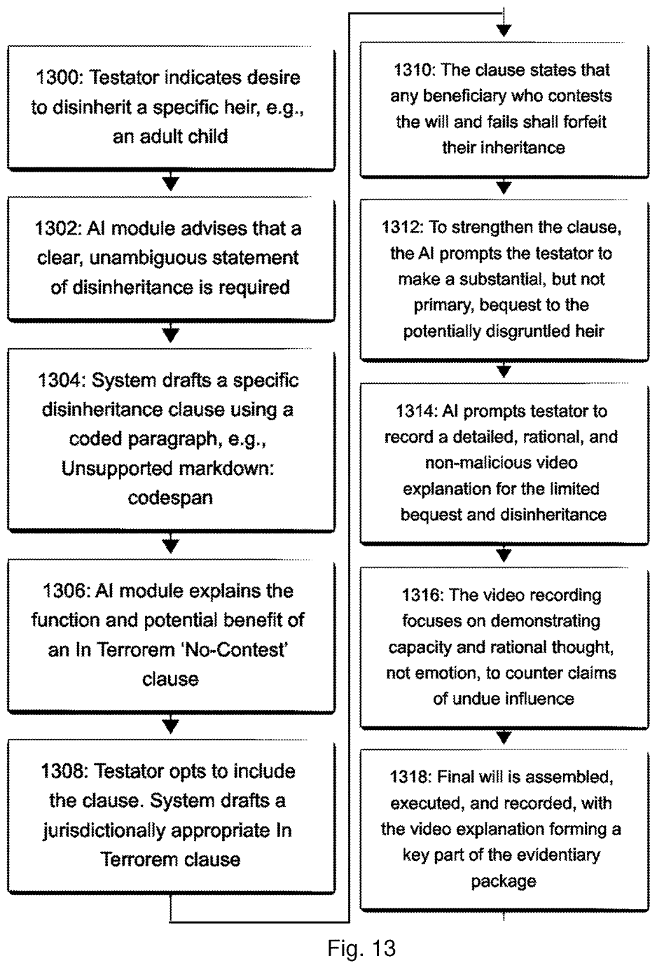

This example, illustrated in FIG. 13, describes the creation of a will that explicitly disinherits a direct heir and includes a no-contest clause to deter a will challenge.

Clear Disinheritance (1300-1304): A testator wishes to disinherit an adult child. The system's AI advises that this must be done with absolute clarity to be effective. It drafts a provision that explicitly names the child and states they are to receive no part of the estate.

Drafting the In Terrorem Clause (1306-1312): The AI then explains the strategic use of an in terrorem, or no-contest, clause. To make this clause effective, the AI advises the testator to leave a substantial, but not equal, bequest to the disinherited child (e.g., $50,000). The in terrorem clause is then drafted to state that should any beneficiary contest the will and lose, they forfeit any bequest they were due to receive. This creates a strong financial disincentive for the child to challenge the will, as they risk losing the $50,000.

The Evidentiary Video (1314-1318): The most critical component is the video recording. The system prompts the testator to record a segment where they calmly and rationally explain their decision. The AI guides them to focus on objective reasons (e.g., “I have provided for my son extensively during my lifetime,” or “Our life paths have diverged significantly”) rather than emotional or angry language. This video, showing a testator who is clearly of sound mind and acting without malice, becomes the primary evidence to defeat any subsequent claim of incapacity or undue influence, thereby giving full legal effect to the in terrorem clause.

### Example 14

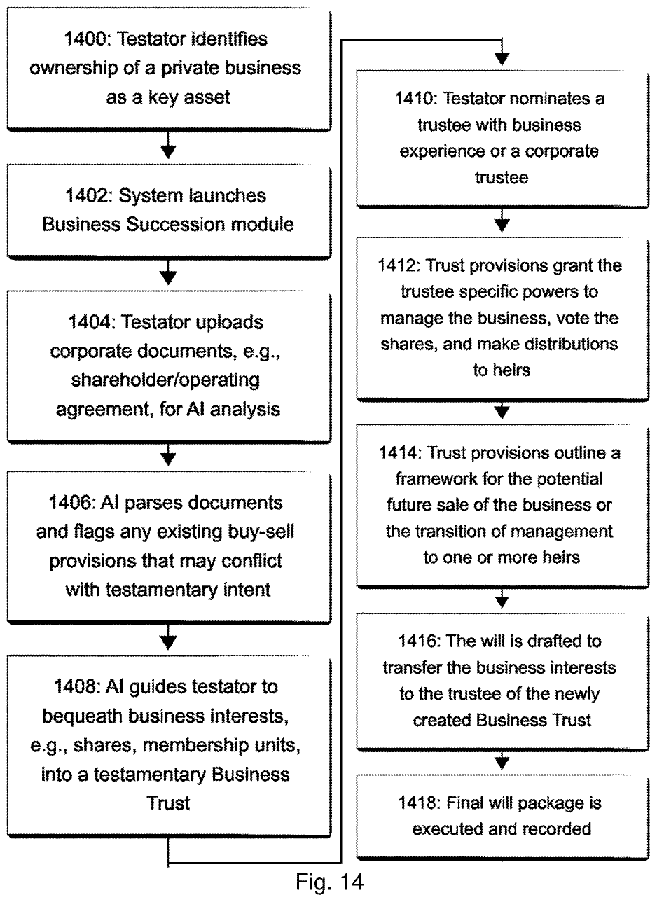

This example, illustrated in FIG. 14, describes the process for a testator who owns a controlling interest in a private company and wishes to ensure its orderly transition after their death.

Analysis of Existing Agreements (1400-1406): A testator identifies their primary asset as their ownership stake in a family-owned manufacturing business. The system prompts the testator to upload the business's key legal documents, such as the shareholder or operating agreement. The AI module parses these documents, specifically searching for buy-sell provisions, rights of first refusal, or other clauses that would be triggered upon the testator's death and could conflict with their desired bequests. The AI presents a report to the testator on how these existing agreements legally constrain their ability to transfer the business.

Creation of a Business Trust (1408-1414): Based on the analysis, the AI advises the creation of a testamentary Business Trust. The testator is guided to transfer their ownership interest not to individual heirs, but to this trust. They nominate a trustee who has business acumen (or a professional corporate trustee). The trust document is drafted with specific, expanded powers, allowing the trustee to vote the shares, appoint directors, oversee management, and decide on the sale or continuation of the business, all while distributing profits to the heir-beneficiaries. This structure prevents disputes among heirs who may have different visions for the business and ensures professional management.

Finalization (1416-1418): The will is drafted with the operative clause bequeathing the business ownership to the trustee of the Business Trust. The final executed will thereby creates a robust legal structure for the continuation and management of the business for the benefit of the testator's family, preventing a forced liquidation or family infighting.

Video wills provide certain advantages compared to traditional hard copy paper wills. For example, the testator's intentions are more clearly discernable from a video recording than from a hardcopy paper writing alone. In addition, the competence of a testator, and whether they were of sound mind and were not manipulated when they made their will can be accurately determined from a video recording whereas no such determination can be made from conventional hardcopy paper documents. Also, video wills eliminate issues in will contests arising from the unavailability of witnesses or notaries.

The present technology can be utilized to create legal documents other than video wills. For example, the technology can be used to prepare a video living will, to prepare a video power of attorney, or to prepare a video contract. The instructions and prompts will vary depending on the type of legal document sought to be recorded. The foregoing non-exclusive examples are not intended to limit the scope of the video legal documents that can be created using the present technology.

Numerous modifications to and alternative embodiments of the present invention will be apparent to those skilled in the art in view of the foregoing description. This description is to be construed as illustrative only and is for the purpose of teaching those skilled in the art the best mode of carrying out the invention. Details of the embodiment may be varied without departing from the spirit of the invention, and the exclusive use of all modifications is hereby reserved.

What is claimed is:

1. A system for creating or modifying a legal instrument, comprising:
a user interface;
at least one automated processor; and
a memory storing instructions that, when executed by the processor, cause the system to:
authenticate and conduct an interrogation of the user to ascertain the user's intent;
record a video of the user expressing a set of terms and conditions of the legal instrument according to the interrogation;
prompt the user through the user interface to at least one of re-record portions of the video and updating the set of terms and conditions, based on at least one of inconsistencies, incompleteness, and ambiguity between the video and the set of terms and conditions, to produce a complete video; and
output information representing the complete video in a manner that is authenticatable with respect to the user and by the updated terms and conditions.

2. The system according to claim 1, wherein the memory stores further instructions that, when executed by the processor, cause the system to:
retrieve a prior version of the legal instrument if exant; and
output the information representing the complete video in a manner that is authenticatable with respect to the user, by the updated terms and conditions, and by version of the legal instrument.

3. The system according to claim 2, wherein:
the output information representing the complete video is recorded on a blockchain rendering a content of the output information immutable based on blockchain authentication; and
a most current prior version of the legal instrument is identified based on records in the blockchain.

4. The system according to claim 1, wherein the memory stores further instructions that, when executed by the processor, cause the system to:
administer a cognitive assessment of the user; and
record the user during administration of the cognitive assessment.

5. The system according to claim 1, wherein the legal instrument is a will, and the memory stores further instructions that, when executed by the processor, cause the system to:
generate a written transcript of the complete video representing the updated set of terms and conditions;
determine applicable required jurisdictional formalities of execution; and
guide the user through execution of the legal instrument according to the applicable required jurisdictional formalities of execution through the user interface.

6. The system according to claim 5, wherein the memory further stores instructions that, when executed by the processor, cause the system to:
interactively determine an inventory of assets of the user;
prompt the user, as part of the terms and conditions, to define a disposition of the inventory of assets; and
automatically update, independent of the user, at least one asset of the inventory of assets.

7. The system according to claim 1, wherein the prompt of the user through the user interface to at least one of re-record portions of the video and update the set of terms and conditions, based on at least one of inconsistencies, incompleteness, and ambiguity between the video and the set of terms and conditions, to produce a complete video, is performed using an artificial intelligence system employing a large language model.

8. A computer-implemented method for creating a legal instrument, comprising:
conducting, by an artificial intelligence module, an interactive interrogation of a user to ascertain an intent of the user;
administering, by the artificial intelligence module, at least one cognitive assessment of the user;
recording a video of the user during the at least one cognitive assessment; and
generating, based on the intent of the user, a legal instrument recorded as a video of the user expressing the intent.

9. The method according to claim 8, further comprising:
prompting the user to at least one of re-record portions of the video and updating the intent, based on at least one of inconsistencies, incompleteness, and ambiguity between the recorded video and the intent; and
outputting the video in a manner that is authenticatable with respect to the user and a contents of the video.

10. The method according to claim 8, further comprising:
retrieving a prior version of the legal instrument if exant; and
outputting the video in a manner that is authenticatable with respect to the user, by the updated terms and conditions, and by a version of the legal instrument.

11. The method according to claim 10, further comprising:
recording the video on a blockchain, rendering a content of the video immutable based on blockchain authentication; and
identifying a most current prior version of the video based on records in the blockchain.

12. The method according to claim 8, wherein the legal instrument is a will, further comprising:
generating a written transcript of the complete video representing the updated set of terms and conditions;
determining applicable required jurisdictional formalities of execution; and
guiding the user through execution of the legal instrument according to the applicable required jurisdictional formalities of execution through the user interface.

13. The method according to claim 12, further comprising:
determining an inventory of assets of the user;
prompting the user to define a disposition of the each asset of the inventory of assets;
automatically updating at least one asset of the inventory of assets; and
prompting the user to reconsider the disposition of the at least one asset based on the intent and a change in the at least one asset.

14. The method according to claim 8, further comprising using an artificial intelligence engine to prompt the user to at least one of re-record portions of the video and updating the intent, based on at least one of inconsistencies, incompleteness, and ambiguity between the video and the intent.

15. A non-transitory computer-readable medium storing instructions which are executable by at least one automated processor, comprising:
instructions identify, via an interface to a public ledger, a digital asset associated with a user;
instructions to prompt the user to define a disposition of the digital asset, via an autonomous smart contract configured to transfer the digital asset to a beneficiary wallet address upon the verification of an off-chain contingency by an oracle; and
instructions to prompt the user to update the autonomous smart contract dependent on an automatically-determine change in the digital asset.

16. The non-transitory computer-readable medium according to claim 15, further comprising:
instructions to administer a cognitive assessment of the user; and
instructions to record a video of the user during administration of the cognitive assessment.

17. The non-transitory computer-readable medium according to claim 15, further comprising:
instructions to record a video of the user defining the disposition of the digital asset;
instructions to prompt the user to at least one of re-record portions of the video and updating the disposition, based on at least one of inconsistencies, incompleteness, and ambiguity between the video and the disposition;
instructions to record authentication information for the video on the public ledger; and
instructions to determine a prior version of the video based on the public ledger.

18. The non-transitory computer-readable medium according to claim 17, further comprising:
instructions to use an artificial intelligence system to prompt of the user through the user interface to at least one of re-record portions of the video and updating the disposition of the digital asset, based on at least one of inconsistencies, incompleteness, and ambiguity between the video and the disposition.

19. The non-transitory computer-readable medium according to claim 17, further comprising:
instructions to generate a written transcript of the video;
instructions to determine applicable required jurisdictional formalities of execution to create a legal instrument; and
instructions to guide the user through execution of the legal instrument according to the applicable required jurisdictional formalities of execution.

20. The non-transitory computer-readable medium according to claim 15, further comprising:
instructions to interactively determine an inventory of assets of the user;
instructions to prompt the user to define a disposition of the inventory of assets; and
instructions to automatically update, independent of the user, at least one asset of the inventory of assets.
